(19) United States
(12) Patent Application Publication
(10) Pub. No.: US 2024/0118680 A1
(43) Pub. Date: Apr. 11, 2024

(54) DATA MODELING AND DIGITAL ASSET TEMPLATE GENERATION TO PROVIDE ASSET INSTANCE INHERITANCE FOR ASSETS WITHIN AN INDUSTRIAL ENVIRONMENT

(71) Applicant: Honeywell International Inc., CHARLOTTE, NC (US)

(72) Inventor: Wolfgang Dinkel, Manneheim (DE)

(21) Appl. No.: 18/045,612

(22) Filed: Oct. 11, 2022

(51) Int. Cl. G05B 19/418

(52) U.S. Cl. CPC G05B 19/41835; G05B 19/4155

(57) ABSTRACT

Various embodiments relate to data modeling and/or digital asset template generation to provide asset instance inheritance for assets within an industrial environment. In an implementation, a request to generate a digital asset template for a first asset within an industrial environment is received. The request includes an asset inheritance identifier related to a second asset within the industrial environment. In response to the request, an asset category for the second asset is determined based on the asset inheritance identifier. Additionally, the digital asset template for the first asset is configured based on one or more asset tasks associated with the asset category for the second asset. A rendering of visualization data associated with the digital asset template is also caused to be presented via an electronic interface of a user computing device.

### TECHNICAL FIELD

The present disclosure generally relates to digitally transforming data related to physical assets in an industrial environment, and more particularly to data modeling and configuring digital processes related to physical assets in an industrial environment.

### BACKGROUND

An industrial environment generally includes physical assets such machines, equipment, and/or other types of physical assets. Often times, certain physical assets in an industrial processing are identical in construction and/or function. For example, a particular industrial environment may include ten atmospheric compressors of the same make and model that perform essentially the same function and/or measure essentially the same type of data for various industrial processes in the industrial environment. Traditionally, digitally maintaining data related to physical assets and respective measurement points in an industrial environment generally involves manual configuration of data objects associated with each physical asset. However, if each individual data object related to each respective physical asset is not reconfigured when a change or update to a data object or function of a particular type of physical asset is made in the industrial environment, performance of physical assets and/or related industrial processes may be reduced.

### SUMMARY

The details of some embodiments of the subject matter described in this specification are set forth in the accompanying drawings and the description below. Other features, aspects, and advantages of the subject matter will become apparent from the description, the drawings, and the claims.

In an embodiment, a system comprises one or more processors, a memory, and one or more programs stored in the memory. The one or more programs comprise instructions configured to receive a request to generate a digital asset template for a first asset within an industrial environment. In one or more embodiments, the request comprises an asset inheritance identifier related to a second asset within the industrial environment. In response to the request, the one or more programs further comprise instructions configured to determine an asset category for the second asset based on the asset inheritance identifier, configure the digital asset template for the first asset based on one or more asset tasks associated with the asset category for the second asset, and/or cause a rendering of visualization data associated with the digital asset template to be presented via an electronic interface of a user computing device.

In another embodiment, a method comprises, at a device with one or more processors and a memory, receiving a request to generate a digital asset template for a first asset within an industrial environment. In one or more embodiments, the request comprises an asset inheritance identifier related to a second asset within the industrial environment. In response to the request, the method also comprises determining an asset category for the second asset based on the asset inheritance identifier, configuring the digital asset template for the first asset based on one or more asset tasks associated with the asset category for the second asset, and/or causing a rendering of visualization data associated with the digital asset template to be presented via an electronic interface of a user computing device.

In yet another embodiment, a non-transitory computer-readable storage medium comprises one or more programs for execution by one or more processors of a device. The one or more programs comprise instructions which, when executed by the one or more processors, cause the device to receive a request to generate a digital asset template for a first asset within an industrial environment. In one or more embodiments, the request comprises an asset inheritance identifier related to a second asset within the industrial environment. The one or more programs also comprise instructions which, when executed by the one or more processors and in response to the request, cause the device to determine an asset category for the second asset based on the asset inheritance identifier, configure the digital asset template for the first asset based on one or more asset tasks associated with the asset category for the second asset, and/or cause a rendering of visualization data associated with the digital asset template to be presented via an electronic interface of a user computing device.

### BRIEF DESCRIPTIONS OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an exemplary networked computing system environment, in accordance with one or more embodiments described herein;

FIG. 2 illustrates a schematic block diagram of a framework of an IoT platform of the networked computing system, in accordance with one or more embodiments described herein;

FIG. 3 illustrates a system that provides an exemplary environment related data modeling and inheritance conventions to support entity instance inheritance, in accordance with one or more embodiments described herein;

FIG. 4 illustrates an exemplary asset entity inheritance system, in accordance with one or more embodiments described herein;

FIG. 5 illustrates an exemplary user computing device system, in accordance with one or more embodiments described herein;

FIG. 6 illustrates a data flow diagram for generating multiple digital asset instances derived from a digital asset template, in accordance with one or more embodiments described herein;

FIG. 7 illustrates another a data flow diagram for generating multiple digital asset instances based on a digital asset template, creating a custom task for a particular digital asset instance, and assigning an operational limit to a digital asset instance in accordance with one or more embodiments described herein;

FIG. 8 illustrates a data flow diagram for assigning one or more digital asset templates to one or more asset categories, in accordance with one or more embodiments described herein;

FIG. 9 illustrates a data flow diagram for generating multiple digital asset instances based on one or more digital asset templates, in accordance with one or more embodiments described herein;

FIG. 10 illustrates an exemplary inspection round checklist generated by an asset entity inheritance system, in accordance with one or more embodiments described herein;

FIG. 11 illustrates a process flow diagram for resolving asset entity inheritance in an asset entity inheritance system, in accordance with one or more embodiments described herein.

FIG. 12 illustrates another process flow diagram for resolving asset entity inheritance in an asset entity inheritance system, in accordance with one or more embodiments described herein.

FIG. 13 illustrates a functional block diagram of a computer that may be configured to execute techniques described in accordance with one or more embodiments described herein.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one embodiment of the present disclosure, and can be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some embodiments, or it can be excluded.

In general, the present disclosure provides for an “Internet-of-Things” or “IoT” platform for enterprise performance management that uses real-time accurate models and visual analytics to deliver intelligent actionable recommendations for sustained peak performance of an enterprise or organization. The IoT platform is an extensible platform that is portable for deployment in any cloud or data center environment for providing an enterprise-wide, top to bottom view, displaying the status of processes, assets, people, and safety. Further, the IoT platform of the present disclosure supports end-to-end capability to execute digital twins against process data and to translate the output into actionable insights, as detailed in the following description.

An industrial environment generally includes physical assets such machines, equipment, and/or other types of physical assets. Often times, certain physical assets in an industrial processing are identical in construction and/or function. For example, a particular industrial environment may include ten atmospheric compressors of the same make and model that perform essentially the same function and/or measure essentially the same type of data for various industrial processes in the industrial environment. Traditionally, digitally maintaining data related to physical assets and respective measurement points in an industrial environment generally involves manual configuration of data objects associated with each physical asset. However, if each individual data object related to each respective physical asset is not reconfigured when a change or update to a data object or function of a particular type of physical asset is made in the industrial environment, performance of physical assets and/or related industrial processes may be reduced.

Given the scope of typical industrial environments, it can take hundreds of man-hours to configure and/or manage databases associated with physical assets and related industrial processes of a particular industrial environment. For example, it is typically desirable to assign each physical asset to a respective data object comprising the particular properties and operational functions associated with the physical asset, which can lead to reduced asset performance, inefficiencies, and/or misallocated technical resources, especially when there are multiple instances of the same type of physical asset employed across the industrial environment. These problems are exponentially compounded depending on the multitude of various types of physical assets in a given industrial environment. Furthermore, when a particular type of physical asset is to be updated or changed, it is typically desirable to update or change each instance of that particular type of physical asset. For example, it is generally desirable to update or change the respective data objects associated with the physical assets in a related database and/or server system.

Thus, to address these and/or other issues, various embodiments of the present disclosure relate to computer-implemented methods, systems, and computer-program products directed to data modeling and/or digital asset template generation to provide asset instance inheritance for assets within an industrial environment. Various embodiments provide for digitally cataloging and maintaining data related to physical assets in an industrial environment. In various embodiments, data modeling and/or inheritance conventions can be provided to support entity instance inheritance for physical assets in an industrial environment. Various embodiments,

In various embodiments, a digital asset template is generated and associated with a particular type of physical asset in an industrial environment. In one or more embodiments, the digital asset template is a data object comprising one or more properties related to the particular type of physical asset with which the digital asset template is associated. Additionally, a digital asset template can be associated with one or more tasks such as, for example, one or more operational tasks. A task correspond to a data object associated with a physical activity to be performed on, or by, the physical asset associated with the digital asset template.

As an example, a particular make and model of fluid pump in an industrial environment may embody certain properties and functionalities. For instance, the particular type of fluid pump may have a plurality of operating modes and may be equipped to take one or more measurements related to the industrial process for which the particular type of fluid pump is employed. In one or more embodiments, the particular type of fluid pump can be associated with a digital asset template in a database and/or server system related to the industrial environment. In various embodiments, the name and the plurality of operating modes of the particular type of fluid pump can be associated with a respective set of properties associated with the digital asset template. Additionally, in various embodiments, the taking of the one or more measurements by the particular type of fluid pump can be associated with one or more respective tasks associated with the digital asset template.

In one or more embodiments, a request to generate a digital asset template associated with a particular type of industrial asset is received by a server system. A digital asset template comprises properties associated with the particular type of industrial asset and tasks associated with physical activities to be performed on, or by, the particular type of industrial asset. A digital asset template can be assigned to one or more asset categories. An asset category can comprise one or more category tasks. Additionally, the digital asset template can inherit the category tasks from the asset category. Multiple digital asset instances can also be derived from the digital asset template and/or can inherit the asset tasks and the category tasks from the digital asset template. The multiple digital asset instances can be associated with multiple respective industrial assets in the industrial environment.

In one or more embodiments, the inheritance conventions of an exemplary asset entity inheritance system are such that a digital asset template can have a one-to-many relationship with one or more digital asset instances. In various embodiments, the digital asset template related to a particular type of physical asset can be used to derive one or more digital asset instances associated with one or more specific physical assets in an industrial environment. In this regard, each of the one or more digital asset instances associated with the one or more specific physical assets in the industrial environment inherits the one or more properties and/or the one or more tasks associated with the digital asset template. Additionally or alternatively, a particular digital asset instance can be configured to comprise one or more custom tasks associated with the specific physical asset for which the particular digital asset instance represents. For example, referring back to the fluid pump example mentioned above, one or more digital asset instances can be derived from the digital asset template associated with the particular type of fluid pump and associated with one or more respective fluid pumps employed in the industrial environment. An individual digital asset instance associated with a specific fluid pump can be updated to include one or more custom tasks associated with the specific fluid pump such that the custom tasks are carried out only for that specific fluid pump, and not for the other one or more digital asset instances derived from the same digital asset template.

In various embodiments, one or more digital asset templates can be assigned to one or more asset categories defined in an exemplary asset entity inheritance system of the present disclosure. In one or more embodiments, asset categories comprise one or more tasks associated with a particular industrial environment management process and/or a particular class of physical asset employed in an industrial environment. For example, the asset entity inheritance system can comprise asset categories such as “maintenance” or “safety” for which particular tasks can be associated. A maintenance asset category can comprise tasks such as “check lube” and/or “replace lube,” where a safety asset category can comprise tasks such as “check safety seal.” Additionally or alternatively, asset categories may encompass various physical assets such as “temperature critical assets” or “pressurized assets” such that multiple types of digital asset templates associated with multiple types of particular physical assets may be assigned to said asset categories. For example, digital asset templates associated with a fluid pump and a motor can be assigned to the maintenance asset category and the temperature critical assets asset category such that the respective digital asset templates associated with the fluid pump and the motor will inherit the tasks associated with said asset categories.

In one or more embodiments, according to the data modeling and inheritance conventions employed in exemplary systems of the present disclosure, one or more digital asset instances associated with one or more respective digital asset templates can be automatically updated in response to an update of the one or more digital asset templates and/or an update to the one or more asset categories to which the one or more digital asset templates are assigned. In various embodiments, an update to the one or more digital asset templates comprises any change to at least one of the one or more properties associated with the digital asset template, the one or more tasks associated with the digital asset template, and/or the one or more tasks associated with the one or more asset categories to which the digital asset template is assigned. In certain embodiments, once an update to a digital asset template and/or an asset category takes place, any digital asset instances associated with and/or derived from the digital asset template and/or asset category are automatically updated in the database and/or server system associated with the particular industrial environment to which the digital asset templates are related.

In certain embodiments, operational limits can be defined for particular digital asset instances associated with specific physical assets. In one or more embodiments, an operational limit is a minimum or maximum acceptable parameter value related to a particular task associated with a particular digital asset instance. For example, if a digital asset template comprises a task related to capturing a pressure measurement, the task will be inherited by one or more digital asset instances derived from the digital asset template. However, an operational limit can be defined for one or more of the digital asset instances such that a different pressure value threshold can be set for the one or more digital asset instances associated with one or more respective physical assets. For instance, “atmospheric compressor X” and “atmospheric compressor Y” both inherited a “capture pressure value” task from a digital asset template “atmospheric compressor” associated with a particular type of physical atmospheric compressor employed in an industrial environment. An operational limit of 3.4 hPa can be defined for the capture pressure value task associated with atmospheric compressor X, whereas an operational limit of 1.7 hPa can be defined for the capture pressure value task associated with atmospheric compressor Y. In various embodiments, if an operational limit associated with a particular digital asset instance is exceeded, one or more actions can be triggered, thereby altering an industrial process related to the specific physical asset associated with the particular digital asset instance. In various embodiments, the one or more actions triggered by the operational limit can include, but are not limited to, alarm triggers, safety measures, industrial process alterations, and/or any actions related to the protection and safety of any equipment and personnel in the industrial environment.

In one or more embodiments, an exemplary asset entity inheritance system can generate an inspection round checklist comprising a list of tasks associated with one or more physical assets in a particular industrial environment. In various embodiments, an exemplary system can compile a list of tasks inherited by one or more digital asset instances from one or more digital asset templates, as well as any customs tasks defined for any particular digital asset instances. In one or more embodiments, the asset entity inheritance system can transmit, via a communications network, the inspection round checklist to one or more user computing device systems associated with the particular industrial environment. In one or more embodiments, the inspection round checklist can be generated and transmitted to a user computing device system on a schedule (e.g., daily, weekly, monthly, etc.) such that one or more plant operators may perform the tasks in the inspection round checklist on a routine basis.

As such, by employing one or more techniques disclosed herein, various technical improvements can be achieved. For example, employing the one or more techniques disclosed herein can reduce the amount of data that needs to be stored in a server system associated with a particular industrial environment by reducing redundancies while at the same time maintaining the option of setting specific configuration parameters (e.g., operational limits) for each digital asset instance. Furthermore, an amount of time for configuring a data model of an industrial environment can be reduced, and, once configured, the data model can be reused for generating inspection round checklists, adding additional physical assets to the industrial environment and initializing corresponding digital asset instances, and/or creating new data models associated with one or more other industrial environments. Additionally, by abstracting the physical assets associated with an industrial environment, operational functions and duties (e.g., tasks) can be defined in an abstract way and can therefore be re-used across different industrial environments within the same industrial enterprise without any additional effort, thus saving time and technical resources.

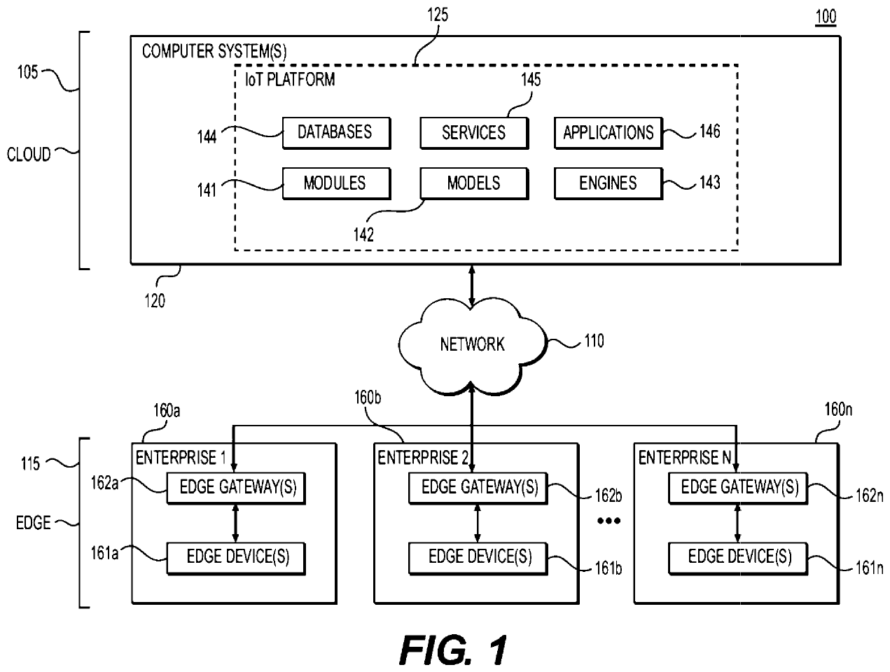

FIG. 1 illustrates an exemplary networked computing system environment 100, according to the present disclosure. As shown in FIG. 1, networked computing system environment 100 is organized into a plurality of layers including a cloud layer 105, a network layer 110, and an edge layer 115. As detailed further below, components of the edge 115 are in communication with components of the cloud 105 via network 110.

In various embodiments, network 110 is any suitable network or combination of networks and supports any appropriate protocol suitable for communication of data to and from components of the cloud 105 and between various other components in the networked computing system environment 100 (e.g., components of the edge 115). According to various embodiments, network 110 includes a public network (e.g., the Internet), a private network (e.g., a network within an organization), or a combination of public and/or private networks. According to various embodiments, network 110 is configured to provide communication between various components depicted in FIG. 1. According to various embodiments, network 110 comprises one or more networks that connect devices and/or components in the network layout to allow communication between the devices and/or components. For example, in one or more embodiments, the network 110 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 is implemented using cellular networks, satellite, licensed radio, or a combination of cellular, satellite, licensed radio, and/or unlicensed radio networks.

Components of the cloud 105 include one or more computer systems 120 that form a so-called “Internet-of-Things” or “IoT” platform 125. It should be appreciated that “IoT platform” is an optional term describing a platform connecting any type of Internet-connected device and should not be construed as limiting on the types of computing systems useable within IoT platform 125. In particular, in various embodiments, computer systems 120 includes any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, in an embodiment, the processors and data storage devices comprise any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of the networked computing system environment 100. In certain embodiments, the networked computing system environment 100 is an on-premise networked computing system where the edge 115 is configured as a process control network and the cloud 105 is configured as an enterprise network.

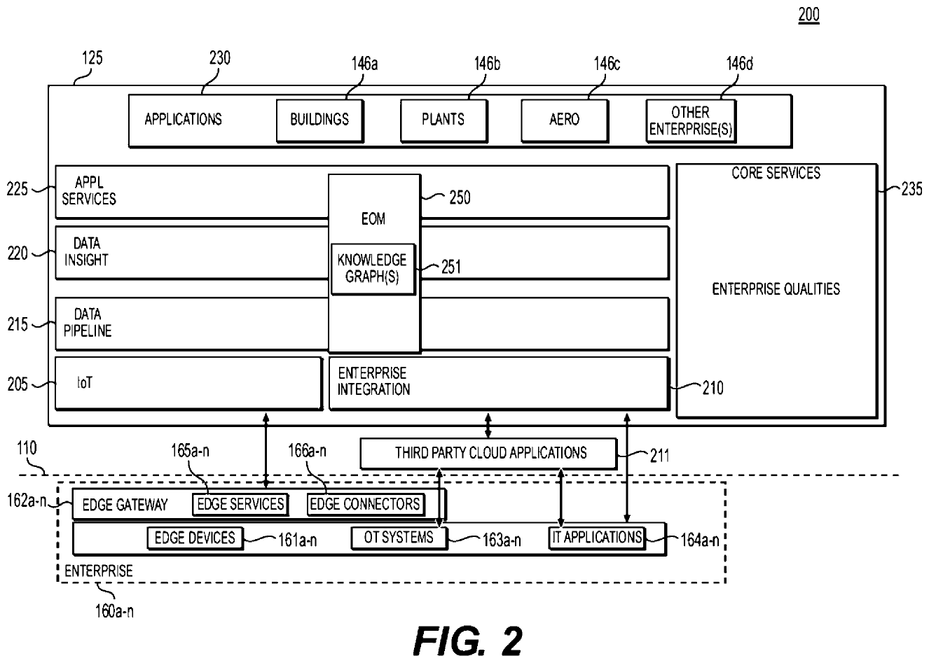

Computer systems 120 further include one or more software components of the IoT platform 125. For example, in one or more embodiments, the software components of computer systems 120 include one or more software modules to communicate with user devices and/or other computing devices through network 110. For example, in one or more embodiments, the software components include one or more modules 141, models 142, engines 143, databases 144, services 145, and/or applications 146, which may be stored in/by the computer systems 120 (e.g., stored on the memory), as detailed with respect to FIG. 2 below. According to various embodiments, the one or more processors are configured to utilize the one or more modules 141, models 142, engines 143, databases 144, services 145, and/or applications 146 when performing various methods described in this disclosure.

Accordingly, in one or more embodiments, computer systems 120 execute a cloud computing platform (e.g., IoT platform 125) with scalable resources for computation and/or data storage and may run one or more applications on the cloud computing platform to perform various computer-implemented methods described in this disclosure. In some embodiments, some of the modules 141, models 142, engines 143, databases 144, services 145, and/or applications 146 are combined to form fewer modules, models, engines, databases, services, and/or applications. In some embodiments, some of the modules 141, models 142, engines 143, databases 144, services 145, and/or applications 146 are separated into separate, more numerous modules, models, engines, databases, services, and/or applications. In some embodiments, some of the modules 141, models 142, engines 143, databases 144, services 145, and/or applications 146 are removed while others are added.

The computer systems 120 are configured to receive data from other components (e.g., components of the edge 115) of networked computing system environment 100 via network 110. Computer systems 120 are further configured to utilize the received data to produce a result. According to various embodiments, information indicating the result is transmitted to users via user computing devices over network 110. In some embodiments, the computer systems 120 is a server system that provides one or more services including providing the information indicating the received data and/or the result(s) to the users. According to various embodiments, computer systems 120 are part of an entity which include any type of company, organization, or institution that implements one or more IoT services. In some examples, the entity is an IoT platform provider.

Components of the edge 115 include one or more enterprises 160a-160n each including one or more edge devices 161a-161n and one or more edge gateways 162a-162n. For example, a first enterprise 160a includes first edge devices 161a and first edge gateways 162a, a second enterprise 160b includes second edge devices 161b and second edge gateways 162b, and an nth enterprise 160n includes nth edge devices 161n and nth edge gateways 162n. As used herein, enterprises 160a-160n represent any type of entity, facility, or vehicle, such as, for example, companies, divisions, buildings, manufacturing plants, warehouses, real estate facilities, laboratories, aircraft, spacecraft, automobiles, ships, boats, military vehicles, oil and gas facilities, or any other type of entity, facility, and/or entity that includes any number of local devices.

According to various embodiments, the edge devices 161a-161n represent any of a variety of different types of devices that may be found within the enterprises 160a-160n. Edge devices 161a-161n are any type of device configured to access network 110, or be accessed by other devices through network 110, such as via an edge gateway 162a-162n. According to various embodiments, edge devices 161a-161n are “IoT devices” which include any type of network-connected (e.g., Internet-connected) device. For example, in one or more embodiments, the edge devices 161a-161n include assets, sensors, actuators, processors, computers, valves, pumps, ducts, vehicle components, cameras, displays, doors, windows, security components, boilers, chillers, pumps, air handler units, HVAC components, factory equipment, and/or any other devices that are connected to the network 110 for collecting, sending, and/or receiving information. Each edge device 161a-161n includes, or is otherwise in communication with, one or more controllers for selectively controlling a respective edge device 161a-161n and/or for sending/receiving information between the edge devices 161a-161n and the cloud 105 via network 110. With reference to FIG. 2, in one or more embodiments, the edge 115 include operational technology (OT) systems 163a-163n and information technology (IT) applications 164a-164n of each enterprise 160a-160n. The OT systems 163a-163n include hardware and software for detecting and/or causing a change, through the direct monitoring and/or control of industrial equipment (e.g., edge devices 161a-161n), assets, processes, and/or events. The IT applications 164a-164n includes network, storage, and computing resources for the generation, management, storage, and delivery of data throughout and between organizations.

The edge gateways 162a-162n include devices for facilitating communication between the edge devices 161a-161n and the cloud 105 via network 110. For example, the edge gateways 162a-162n include one or more communication interfaces for communicating with the edge devices 161a-161n and for communicating with the cloud 105 via network 110. According to various embodiments, the communication interfaces of the edge gateways 162a-162n include one or more cellular radios, Bluetooth, WiFi, near-field communication radios, Ethernet, or other appropriate communication devices for transmitting and receiving information. According to various embodiments, multiple communication interfaces are included in each gateway 162a-162n for providing multiple forms of communication between the edge devices 161a-161n, the gateways 162a-162n, and the cloud 105 via network 110. For example, in one or more embodiments, communication are achieved with the edge devices 161a-161n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

According to various embodiments, the edge gateways 162a-162n also include a processor and memory for storing and executing program instructions to facilitate data processing. For example, in one or more embodiments, the edge gateways 162a-162n are configured to receive data from the edge devices 161a-161n and process the data prior to sending the data to the cloud 105. Accordingly, in one or more embodiments, the edge gateways 162a-162n include one or more software modules or components for providing data processing services and/or other services or methods of the present disclosure. With reference to FIG. 2, each edge gateway 162a-162n includes edge services 165a-165n and edge connectors 166a-166n. According to various embodiments, the edge services 165a-165n include hardware and software components for processing the data from the edge devices 161a-161n. According to various embodiments, the edge connectors 166a-166n include hardware and software components for facilitating communication between the edge gateway 162a-162n and the cloud 105 via network 110, as detailed above. In some cases, any of edge devices 161a-n, edge connectors 166a-n, and edge gateways 162a-n have their functionality combined, omitted, or separated into any combination of devices. In other words, an edge device and its connector and gateway need not necessarily be discrete devices.

FIG. 2 illustrates a schematic block diagram of framework 200 of the IoT platform 125, according to the present disclosure. The IoT platform 125 of the present disclosure is a platform for enterprise performance management that uses real-time accurate models and visual analytics to deliver intelligent actionable recommendations and/or analytics for sustained peak performance of the enterprise 160a-160n. The IoT platform 125 is an extensible platform that is portable for deployment in any cloud or data center environment for providing an enterprise-wide, top to bottom view, displaying the status of processes, assets, people, and safety. Further, the IoT platform 125 supports end-to-end capability to execute digital twins against process data and to translate the output into actionable insights, using the framework 200, detailed further below.

As shown in FIG. 2, the framework 200 of the IoT platform 125 comprises a number of layers including, for example, an IoT layer 205, an enterprise integration layer 210, a data pipeline layer 215, a data insight layer 220, an application services layer 225, and an applications layer 230. The IoT platform 125 also includes a core services layer 235 and an extensible object model (EOM) 250 comprising one or more knowledge graphs 251. The layers 205-235 further include various software components that together form each layer 205-235. For example, in one or more embodiments, each layer 205-235 includes one or more of the modules 141, models 142, engines 143, databases 144, services 145, applications 146, or combinations thereof. In some embodiments, the layers 205-235 are combined to form fewer layers. In some embodiments, some of the layers 205-235 are separated into separate, more numerous layers. In some embodiments, some of the layers 205-235 are removed while others may be added. In certain embodiments, the framework 200 can be an on-premise framework where the edge devices 161a-161n are configured as part of a process control network and the IoT platform 125 is configured as an enterprise network.

The IoT platform 125 is a model-driven architecture. Thus, the extensible object model 250 communicates with each layer 205-230 to contextualize site data of the enterprise 160a-160n using an extensible graph-based object model (or “asset model”). In one or more embodiments, the extensible object model 250 is associated with knowledge graphs 251 where the equipment (e.g., edge devices 161a-161n) and processes of the enterprise 160a-160n are modeled. The knowledge graphs 251 of EOM 250 are configured to store the models in a central location. The knowledge graphs 251 define a collection of nodes and links that describe real-world connections that enable smart systems. As used herein, a knowledge graph 251: (i) describes real-world entities (e.g., edge devices 161a-161n) and their interrelations organized in a graphical interface; (ii) defines possible classes and relations of entities in a schema; (iii) enables interrelating arbitrary entities with each other; and (iv) covers various topical domains. In other words, the knowledge graphs 251 define large networks of entities (e.g., edge devices 161a-161n), semantic types of the entities, properties of the entities, and relationships between the entities. Thus, the knowledge graphs 251 describe a network of “things” that are relevant to a specific domain or to an enterprise or organization. Knowledge graphs 251 are not limited to abstract concepts and relations, but can also contain instances of objects, such as, for example, documents and datasets. In some embodiments, the knowledge graphs 251 include resource description framework (RDF) graphs. As used herein, a “RDF graph” is a graph data model that formally describes the semantics, or meaning, of information. The RDF graph also represents metadata (e.g., data that describes data). According to various embodiments, knowledge graphs 251 also include a semantic object model. The semantic object model is a subset of a knowledge graph 251 that defines semantics for the knowledge graph 251. For example, the semantic object model defines the schema for the knowledge graph 251.

As used herein, EOM 250 includes a collection of application programming interfaces (APIs) that enables seeded semantic object models to be extended. For example, the EOM 250 of the present disclosure enables a customer's knowledge graph 251 to be built subject to constraints expressed in the customer's semantic object model. Thus, the knowledge graphs 251 are generated by customers (e.g., enterprises or organizations) to create models of the edge devices 161a-161n of an enterprise 160a-160n, and the knowledge graphs 251 are input into the EOM 250 for visualizing the models (e.g., the nodes and links).

The models describe the assets (e.g., the nodes) of an enterprise (e.g., the edge devices 161a-161n) and describe the relationship of the assets with other components (e.g., the links). The models also describe the schema (e.g., describe what the data is), and therefore the models are self-validating. For example, in one or more embodiments, the model describes the type of sensors mounted on any given asset (e.g., edge device 161a-161n) and the type of data that is being sensed by each sensor. According to various embodiments, a KPI framework is used to bind properties of the assets in the extensible object model 250 to inputs of the KPI framework. Accordingly, the IoT platform 125 is an extensible, model-driven end-to-end stack including: two-way model sync and secure data exchange between the edge 115 and the cloud 105, metadata driven data processing (e.g., rules, calculations, and aggregations), and model driven visualizations and applications. As used herein, “extensible” refers to the ability to extend a data model to include new properties/columns/fields, new classes/tables, and new relations. Thus, the IoT platform 125 is extensible with regards to edge devices 161a-161n and the applications 146 that handle those devices 161a-161n. For example, when new edge devices 161a-161n are added to an enterprise 160a-160n system, the new devices 161a-161n will automatically appear in the IoT platform 125 so that the corresponding applications 146 understand and use the data from the new devices 161a-161n.

In some cases, asset templates are used to facilitate configuration of instances of edge devices 161a-161n in the model using common structures. An asset template defines the typical properties for the edge devices 161a-161n of a given enterprise 160a-160n for a certain type of device. For example, an asset template of a pump includes modeling the pump having inlet and outlet pressures, speed, flow, etc. The templates may also include hierarchical or derived types of edge devices 161a-161n to accommodate variations of a base type of device 161a-161n. For example, a reciprocating pump is a specialization of a base pump type and would include additional properties in the template. Instances of the edge device 161a-161n in the model are configured to match the actual, physical devices of the enterprise 160a-160n using the templates to define expected attributes of the device 161a-161n. Each attribute is configured either as a static value (e.g., capacity is 1000 BPH) or with a reference to a time series tag that provides the value. The knowledge graph 251 can automatically map the tag to the attribute based on naming conventions, parsing, and matching the tag and attribute descriptions and/or by comparing the behavior of the time series data with expected behavior. In one or more embodiments, each of the key attribute contributing to one or more metrics to drive a dashboard is marked with one or more metric tags such that a dashboard visualization is generated.

The modeling phase includes an onboarding process for syncing the models between the edge 115 and the cloud 105. For example, in one or more embodiments, the onboarding process includes a simple onboarding process, a complex onboarding process, and/or a standardized rollout process. The simple onboarding process includes the knowledge graph 251 receiving raw model data from the edge 115 and running context discovery algorithms to generate the model. The context discovery algorithms read the context of the edge naming conventions of the edge devices 161a-161n and determine what the naming conventions refer to. For example, in one or more embodiments, the knowledge graph 251 receives “TMP” during the modeling phase and determine that “TMP” relates to “temperature.” The generated models are then published. The complex onboarding process includes the knowledge graph 251 receiving the raw model data, receiving point history data, and receiving site survey data. According to various embodiments, the knowledge graph 251 then uses these inputs to run the context discovery algorithms. According to various embodiments, the generated models are edited and then the models are published. The standardized rollout process includes manually defining standard models in the cloud 105 and pushing the models to the edge 115.

The IoT layer 205 includes one or more components for device management, data ingest, and/or command/control of the edge devices 161a-161n. The components of the IoT layer 205 enable data to be ingested into, or otherwise received at, the IoT platform 125 from a variety of sources. For example, in one or more embodiments, data is ingested from the edge devices 161a-161n through process historians or laboratory information management systems. The IoT layer 205 is in communication with the edge connectors 165a-165n installed on the edge gateways 162a-162n through network 110, and the edge connectors 165a-165n send the data securely to the IoT platform 205. In some embodiments, only authorized data is sent to the IoT platform 125, and the IoT platform 125 only accepts data from authorized edge gateways 162a-162n and/or edge devices 161a-161n. According to various embodiments, data is sent from the edge gateways 162a-162n to the IoT platform 125 via direct streaming and/or via batch delivery. Further, after any network or system outage, data transfer will resume once communication is re-established and any data missed during the outage will be backfilled from the source system or from a cache of the IoT platform 125. According to various embodiments, the IoT layer 205 also includes components for accessing time series, alarms and events, and transactional data via a variety of protocols.

The enterprise integration layer 210 includes one or more components for events/messaging, file upload, and/or REST/OData. The components of the enterprise integration layer 210 enable the IoT platform 125 to communicate with third party cloud applications 211, such as any application(s) operated by an enterprise in relation to its edge devices. For example, the enterprise integration layer 210 connects with enterprise databases, such as guest databases, customer databases, financial databases, patient databases, etc. The enterprise integration layer 210 provides a standard application programming interface (API) to third parties for accessing the IoT platform 125. The enterprise integration layer 210 also enables the IoT platform 125 to communicate with the OT systems 163a-163n and IT applications 164a-164n of the enterprise 160a-160n. Thus, the enterprise integration layer 210 enables the IoT platform 125 to receive data from the third-party applications 211 rather than, or in combination with, receiving the data from the edge devices 161a-161n directly. In certain embodiments, the enterprise integration layer 210 enables a scalable architecture to expand interfaces to multiple systems and/or system configurations. In certain embodiments, the enterprise integration layer 210 enables integration with an indoor navigation system related to the enterprise 160a-160n.

The data pipeline layer 215 includes one or more components for data cleansing/enriching, data transformation, data calculations/aggregations, and/or API for data streams. Accordingly, in one or more embodiments, the data pipeline layer 215 pre-processes and/or performs initial analytics on the received data. The data pipeline layer 215 executes advanced data cleansing routines including, for example, data correction, mass balance reconciliation, data conditioning, component balancing and simulation to ensure the desired information is used as a basis for further processing. The data pipeline layer 215 also provides advanced and fast computation. For example, cleansed data is run through enterprise-specific digital twins. According to various embodiments, the enterprise-specific digital twins include a reliability advisor containing process models to determine the current operation and the fault models to trigger any early detection and determine an appropriate resolution. According to various embodiments, the digital twins also include an optimization advisor that integrates real-time economic data with real-time process data, selects the right feed for a process, and determines optimal process conditions and product yields.

According to various embodiments, the data pipeline layer 215 employs models and templates to define calculations and analytics. Additionally or alternatively, according to various embodiments, the data pipeline layer 215 employs models and templates to define how the calculations and analytics relate to the assets (e.g., the edge devices 161a-161n). For example, in an embodiment, a pump template defines pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. According to various embodiments, the actual calculation or analytic logic is defined in the template or it may be referenced. Thus, according to various embodiments, the calculation model is employed to describe and control the execution of a variety of different process models. According to various embodiments, calculation templates are linked with the asset templates such that when an asset (e.g., edge device 161a-161n) instance is created, any associated calculation instances are also created with their input and output parameters linked to the appropriate attributes of the asset (e.g., edge device 161a-161n).

According to various embodiments, the IoT platform 125 supports a variety of different analytics models including, for example, first principles models, empirical models, engineered models, user-defined models, machine learning models, built-in functions, and/or any other types of analytics models. Fault models and predictive maintenance models will now be described by way of example, but any type of models may be applicable.

Fault models are used to compare current and predicted enterprise 160a-160n performance to identify issues or opportunities, and the potential causes or drivers of the issues or opportunities. The IoT platform 125 includes rich hierarchical symptom-fault models to identify abnormal conditions and their potential consequences. For example, in one or more embodiments, the IoT platform 125 drill downs from a high-level condition to understand the contributing factors, as well as determining the potential impact a lower level condition may have. There may be multiple fault models for a given enterprise 160a-160n looking at different aspects such as process, equipment, control, and/or operations. According to various embodiments, each fault model identifies issues and opportunities in their domain, and can also look at the same core problem from a different perspective. According to various embodiments, an overall fault model is layered on top to synthesize the different perspectives from each fault model into an overall assessment of the situation and point to the true root cause.

According to various embodiments, when a fault or opportunity is identified, the IoT platform 125 provides recommendations about an optimal corrective action to take. Initially, the recommendations are based on expert knowledge that has been pre-programmed into the system by process and equipment experts. A recommendation services module presents this information in a consistent way regardless of source, and supports workflows to track, close out, and document the recommendation follow-up. According to various embodiments, the recommendation follow-up is employed to improve the overall knowledge of the system over time as existing recommendations are validated (or not) or new cause and effect relationships are learned by users and/or analytics.

According to various embodiments, the models are used to accurately predict what will occur before it occurs and interpret the status of the installed base. Thus, the IoT platform 125 enables operators to quickly initiate maintenance measures when irregularities occur. According to various embodiments, the digital twin architecture of the IoT platform 125 employs a variety of modeling techniques. According to various embodiments, the modeling techniques include, for example, rigorous models, fault detection and diagnostics (FDD), descriptive models, predictive maintenance, prescriptive maintenance, process optimization, and/or any other modeling technique.

According to various embodiments, the rigorous models are converted from process design simulation. In this manner, process design is integrated with feed conditions and production requirement. Process changes and technology improvement provide opportunities that enable more effective maintenance schedule and deployment of resources in the context of production needs. The fault detection and diagnostics include generalized rule sets that are specified based on industry experience and domain knowledge and can be easily incorporated and used working together with equipment models. According to various embodiments, the descriptive models identifies a problem and the predictive models determines possible damage levels and maintenance options. According to various embodiments, the descriptive models include models for defining the operating windows for the edge devices 161a-161n.

Predictive maintenance includes predictive analytics models developed based on rigorous models and statistic models, such as, for example, principal component analysis (PCA) and partial least square (PLS). According to various embodiments, machine learning methods are applied to train models for fault prediction. According to various embodiments, predictive maintenance leverages FDD-based algorithms to continuously monitor individual control and equipment performance. Predictive modeling is then applied to a selected condition indicator that deteriorates in time. Prescriptive maintenance includes determining an optimal maintenance option and when it should be performed based on actual conditions rather than time-based maintenance schedule. According to various embodiments, prescriptive analysis selects the right solution based on the company's capital, operational, and/or other requirements. Process optimization is determining optimal conditions via adjusting set-points and schedules. The optimized set-points and schedules can be communicated directly to the underlying controllers, which enables automated closing of the loop from analytics to control.

The data insight layer 220 includes one or more components for time series databases (TDSB), relational/document databases, data lakes, blob, files, images, and videos, and/or an API for data query. According to various embodiments, when raw data is received at the IoT platform 125, the raw data is stored as time series tags or events in warm storage (e.g., in a TDSB) to support interactive queries and to cold storage for archive purposes. According to various embodiments, data is sent to the data lakes for offline analytics development. According to various embodiments, the data pipeline layer 215 accesses the data stored in the databases of the data insight layer 220 to perform analytics, as detailed above.

The application services layer 225 includes one or more components for rules engines, workflow/notifications, KPI framework, insights (e.g., actionable insights), decisions, recommendations, machine learning, and/or an API for application services. The application services layer 225 enables building of applications 146a-d. The applications layer 230 includes one or more applications 146a-d of the IoT platform 125. For example, according to various embodiments, the applications 146a-d includes a buildings application 146a, a plants application 146b, an aero application 146c, and other enterprise applications 146d. According to various embodiments, the applications 146 includes general applications 146 for portfolio management, asset management, autonomous control, and/or any other custom applications. According to various embodiments, portfolio management includes the KPI framework and a flexible user interface (UI) builder. According to various embodiments, asset management includes asset performance and asset health. According to various embodiments, autonomous control includes energy optimization and/or predictive maintenance. As detailed above, according to various embodiments, the general applications 146 is extensible such that each application 146 is configurable for the different types of enterprises 160a-160n (e.g., buildings application 146a, plants application 146b, aero application 146c, and other enterprise applications 146d).

The applications layer 230 also enables visualization of performance of the enterprise 160a-160n. For example, dashboards provide a high-level overview with drill downs to support deeper investigations. Recommendation summaries give users prioritized actions to address current or potential issues and opportunities. Data analysis tools support ad hoc data exploration to assist in troubleshooting and process improvement.

The core services layer 235 includes one or more services of the IoT platform 125. According to various embodiments, the core services 235 include data visualization, data analytics tools, security, scaling, and monitoring. According to various embodiments, the core services 235 also include services for tenant provisioning, single login/common portal, self-service admin, UI library/UI tiles, identity/access/entitlements, logging/monitoring, usage metering, API gateway/dev portal, and the IoT platform 125 streams.

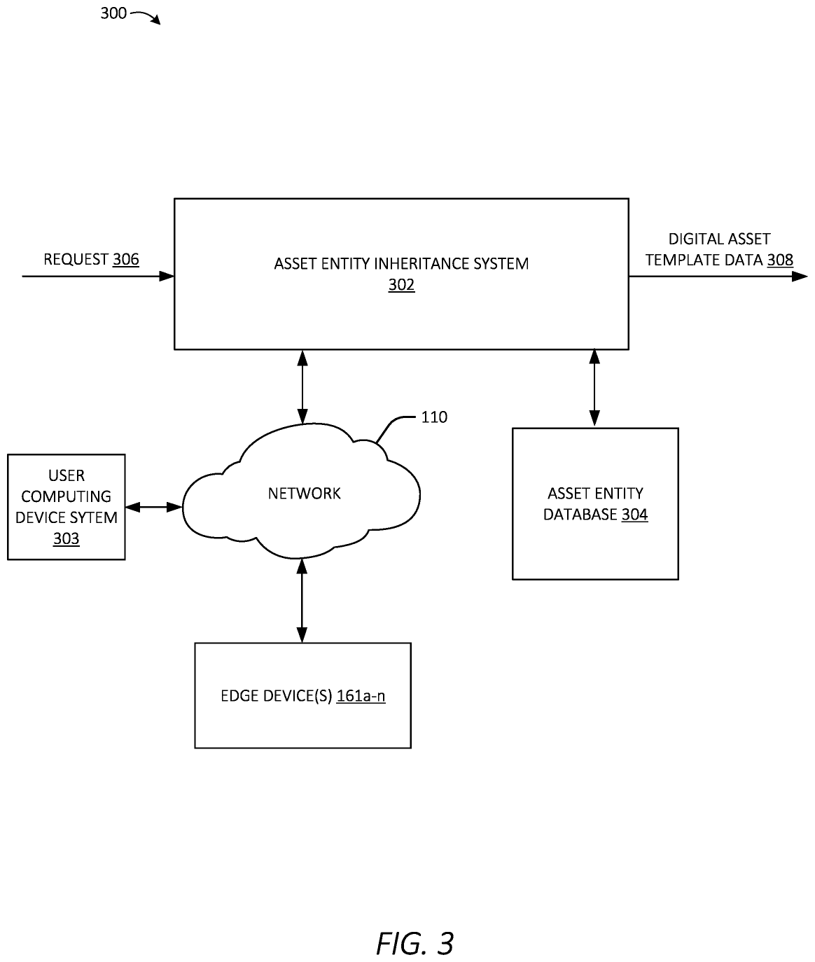

FIG. 3 illustrates a system 300 that provides another exemplary environment according to one or more described features of one or more embodiments of the disclosure. According to an embodiment, the system 300 includes an asset entity inheritance system 302. The asset entity inheritance system 302 is associated with one or more application products such as an asset entity inheritance platform, a data modeling platform, an asset management platform, an asset performance platform, a global operations platform, a site operations platform, an industrial asset platform, an industrial process platform, a digital worker platform, an energy and sustainability platform, a healthy buildings platform, an energy optimization platform, a predictive maintenance platform, a centralized control platform, and/or another type of asset platform. In one or more embodiments, the asset entity inheritance system 302 receives the request 306 from a user computing device system 303. In certain embodiments, the asset entity inheritance system 302 receives the request 306 via the network 110. Additionally, in one or more embodiments, the asset entity inheritance system 302 transmits the digital asset template data 308 to the user computing device system 303. In certain embodiments, the asset entity inheritance system 302 transmits the digital asset template data 308 via the network 110.

In an embodiment, the asset entity inheritance system 302 receives data from the edge devices 161a-161n. In one or more embodiments, at least a portion of the data from the edge devices 161a-161n is included in the digital asset template data 308. In one or more embodiments, the edge devices 161a-161n are associated with a portfolio of assets. For instance, in one or more embodiments, the edge devices 161a-161n include one or more assets in a portfolio of assets. The edge devices 161a-161n include, in one or more embodiments, one or more databases, one or more assets (e.g., one or more industrial assets, one or more building assets, etc.), one or more IoT devices (e.g., one or more industrial IoT devices), one or more connected building assets, one or more sensors, one or more actuators, one or more processors, one or more computers, one or more valves, one or more pumps (e.g., one or more centrifugal pumps, etc.), one or more motors, one or more compressors, one or more turbines, one or more ducts, one or more heaters, one or more chillers, one or more coolers, one or more boilers, one or more furnaces, one or more heat exchangers, one or more fans, one or more blowers, one or more conveyor belts, one or more vehicle components, one or more cameras, one or more displays, one or more security components, one or more air handler units, one or more HVAC components, industrial equipment, factory equipment, and/or one or more other devices that are connected to the network 110 for collecting, sending, and/or receiving information. In one or more embodiments, the edge device 161a-161n include, or is otherwise in communication with, one or more controllers for selectively controlling a respective edge device 161a-161n and/or for sending/receiving information between the edge devices 161a-161n and the asset entity inheritance system 302 via the network 110. The data associated with the edge devices 161a-161n includes, for example, industrial asset data related to one or more physical assets associated with one or more respective digital asset instances (e.g., asset properties, asset configuration data, operational functionality data, etc.), sensor data, real-time data, live property value data, event data, process data, operational data, fault data, industrial asset data, location data, and/or other data associated with the edge devices 161a-161n. Additionally or alternatively, the data associated with the edge devices 161a-161n includes historical data, historical industrial asset data (e.g., historical asset configuration data), historical sensor data, historical property value data, historical event data, historical process data, historical operational data, historical fault data, historical asset data, and/or other historical data associated with the edge devices 161a-161n.

In certain embodiments, at least one edge device from the edge devices 161a-161n incorporates encryption capabilities to facilitate encryption of one or more portions of the industrial asset data. Additionally, in one or more embodiments, the asset entity inheritance system 302 receives the data associated with the edge devices 161a-161n via the network 110. In one or more embodiments, the network 110 is a Wi-Fi network, an NFC network, a WiMAX network, a PAN, a short-range wireless network (e.g., a Bluetooth® network), an infrared wireless (e.g., IrDA) network, a UWB network, an induction wireless transmission network, and/or another type of network. In one or more embodiments, the edge devices 161a-161n are associated with an industrial environment (e.g., a plant, etc.). Additionally or alternatively, in one or more embodiments, the edge devices 161a-161n are associated with components of the edge 115 such as, for example, one or more enterprises 160a-160n.

In one or more embodiments, the asset entity inheritance system 302 aggregates the data associated with the edge devices 161a-161n from the edge devices 161a-161n. For instance, in one or more embodiments, the asset entity inheritance system 302 aggregates the data associated with the edge devices 161a-161n into an asset entity database 304. The asset entity database 304 is a cache memory (e.g., a database structure) that dynamically stores the data associated with the edge devices 161a-161n based on interval of time and/or asset hierarchy level. For instance, in one or more embodiments, the asset entity database 304 stores the data associated with the edge devices 161a-161n for one or more intervals of time (e.g., 1 minute to 12 minutes, 1 hour to 24 hours, 1 day to 31 days, 1 month to 12 months, etc.) and/or for one or more asset hierarchy levels (e.g., asset level, asset zone, building level, building zone, plant level, plant zone, industrial site level, etc.). In a non-limiting embodiment, the asset entity database 304 stores the data associated with the edge devices 161a-161n for a first interval of time (e.g., 1 hour to 24 hours minutes) for a first asset (e.g., a first asset hierarchy level), for a second interval of time (e.g., 1 day to 31 days) for the first asset, and for a third interval of time (e.g., 1 month to 12 months) for the first asset. Furthermore, in the non-limiting embodiment, the asset entity database 304 stores the data associated with the edge devices 161a-161n for the first interval of time (e.g., 1 hour to 24 hours minutes) for all assets in an industrial environment (e.g., a second asset hierarchy level), for the second interval of time (e.g., 1 day to 31 days) for all the assets in the industrial environment, and for the third interval of time (e.g., 1 month to 12 months) for the all the assets in the industrial environment.

In one or more embodiments, the asset entity inheritance system 302 repeatedly updates data of the asset entity database 304 based on the data provided by the edge devices 161a-161n during the one or more intervals of time associated with the asset entity database 304. For instance, in one or more embodiments, the asset entity inheritance system 302 stores new data and/or modified data associated with the edge devices 161a-161n. In one or more embodiments, the asset entity inheritance system 302 repeatedly scans the edge devices 161a-161n to determine new data for storage in the asset entity database 304. In one or more embodiments, the asset entity inheritance system 302 formats one or more portions of the data associated with the edge devices 161a-161n. For instance, in one or more embodiments, the asset entity inheritance system 302 provides a formatted version of the data associated with the edge devices 161a-161n to the asset entity database 304. In an embodiment, the formatted version of the industrial asset data is formatted with one or more defined formats associated with the one or more intervals of time and/or the one or more asset hierarchy levels. A defined format is, for example, a structure for data fields of the asset entity database 304. In various embodiments, the formatted version of the data associated with the edge devices 161a-161n is stored in the asset entity database 304.

In one or more embodiments, the asset entity inheritance system 302 identifies and/or groups data types for data associated with the edge devices 161a-161n based on the one or more intervals of time (e.g., one or more reporting intervals of time) and/or the one or more asset hierarchy levels. In one or more embodiments, the asset entity inheritance system 302 employs batching, concatenation of data associated with the edge devices 161a-161n, identification of data types, merging of data associated with the edge devices 161a-161n, grouping of data associated with the edge devices 161a-161n, reading of data associated with the edge devices 161a-161n, and/or writing of data associated with the edge devices 161a-161n to facilitate storage of data associated with the edge devices 161a-161n within the asset entity database 304. In one or more embodiments, the asset entity inheritance system 302 groups data associated with the edge devices 161a-161n based on corresponding features and/or attributes of the data. In one or more embodiments, the asset entity inheritance system 302 groups data associated with the edge devices 161a-161n based on corresponding identifiers (e.g., a matching asset hierarchy level, a matching asset, a matching industrial environment, etc.) for the industrial asset data. In one or more embodiments, the asset entity inheritance system 302 employs one or more locality-sensitive hashing techniques to group data associated with the edge devices 161a-161n based on similarity scores and/or calculated distances between different data associated with the edge devices 161a-161n. In one or more embodiments, at least a portion of the data stored in the asset entity database 304 is included in the digital asset template data 308.

In various embodiments, the asset entity inheritance system 302 can receive the request 306. In one or more embodiments, the request 306 is a request to generate one or more digital asset templates associated with one or more respective, particular types of assets (e.g., physical assets, edge devices 161a-161n) employed in a particular industrial environment. For example, the request 306 can be a request to generate a digital asset template for a first asset within an industrial environment. In one or more embodiments, the request 306 includes at least an asset inheritance identifier related to a second asset within the industrial environment. For example, the asset inheritance identifier can identify an asset and/or a related asset category for an asset similarly configured to and/or corresponding to a same type of asset as the first asset.

In response to the request 306, the asset entity inheritance system 302 can determine an asset category for the second asset based on the asset inheritance identifier. Additionally, in response to the request 306, the asset entity inheritance system 302 can configure the digital asset template for the first asset based on one or more asset tasks associated with the asset category for the second asset. In one or more embodiments, the asset entity inheritance system 302, in response to the request 306, can initialize the one or more digital asset templates associated with the one or more respective, particular types of industrial asset in a server system associated with the particular industrial environment. In various embodiments, the server system associated with the particular industrial environment can integrate with, or be embodied by, the asset entity database 304.

In various embodiments, the asset entity inheritance system 302 can define a digital asset template to have one or more properties associated with various characteristics of the particular type of physical industrial asset associated with the digital asset template. Additionally, the asset entity inheritance system 302 can associate one or more asset tasks to the digital asset template, where the asset tasks are related to one or more operational functionalities and/or measurement points of the particular type of physical industrial asset associated with the digital asset template. In various embodiments, the asset entity inheritance system 302 can assign the digital asset template to one or more asset categories where the one or more asset categories comprise one or more category tasks. In various embodiments, the one or more category tasks are associated with a physical activity to be performed on the particular type of physical asset associated with the digital asset template, and where the digital asset template inherits the one or more category tasks from the asset category. In one or more embodiments, the asset entity inheritance system 302 can generate one or more digital asset instances. In various embodiments, the one or more digital asset instances are data objects derived from the digital asset template. In various embodiments, the one or more digital asset instances inherit the one or more asset tasks and the one or more category tasks from the digital asset template. In one or more embodiments, the asset entity inheritance system 302 can associate the one or more digital asset instances with one or more respective physical assets in the industrial environment. In one or more embodiments, the asset entity inheritance system 302 can store the one or more digital asset instances in the asset entity database 304.

In one or more embodiments, the user computing device system 303 is in communication with the asset entity inheritance system 302 via the network 110. In one or more embodiments, the user computing device system 303 is integrated within or corresponds to a mobile computing device, a smartphone, a tablet computer, a mobile computer, a desktop computer, a laptop computer, a workstation computer, a wearable device, a virtual reality device, an augmented reality device, or another type of computing device located remote from the asset entity inheritance system 302. In an embodiment, the user computing device system 303 transmits the request 306 to the asset entity inheritance system 302 via the network 110. In another embodiment, the asset entity inheritance system 302 transmits the digital asset template data 308 to the user computing device system 303 via the network 110.

In one or more embodiments, the digital asset template data 308 includes one or more visual elements for the visual display (e.g., as rendered by the electronic interface component 508) of the user computing device system 303 that renders an interactive user interface based on a respective user interface configuration. For example, the asset entity inheritance system 302 can cause a rendering of visualization data associated with the digital asset template to be presented via an electronic interface of a user computing device. In various embodiments, the rendering can be caused via one or more computer-executable instructions included in the digital asset template data 308. In certain embodiments, the visual display of the user computing device system 303 displays one or more graphical elements associated with the digital asset template data 308. In certain embodiments, the electronic interface component 508 of the user computing device system 303 renders one or more interactive display elements associated with the digital asset template data 308. In certain embodiments, the asset entity inheritance system 302 can configure the electronic interface to render an inspection round checklist related to the first asset based on the digital asset template. The inspection round checklist can include the one or more asset tasks, in various embodiments. In certain embodiments, the asset entity inheritance system 302 can configure, based on the digital asset template, the electronic interface to capture a parameter value associated with an asset task from the one or more assets tasks for the first asset. In another example, in one or more embodiments, the digital asset template data 308 includes one or notifications associated with the digital asset template data 308. In one or more embodiments, the digital asset template data 308 allows a user associated with the user computing device system 303 to make decisions and/or perform one or more actions with respect to configuring digital asset templates, generating digital asset instances, configuring one or more industrial processes related to one or more assets based at least in part on the digital asset templates, determining parameters related the one or more industrial processes associated with the digital asset templates, defining asset tasks, defining asset categories, and/or generating inspection round checklists associated with the digital asset instances corresponding to the physical assets of a particular industrial environment.

In certain embodiments, the asset entity inheritance system 302 can determine a change to an asset task for the second asset. Furthermore, the asset entity inheritance system 302 can update the one or more asset tasks associated with the asset category to generate one or more updated asset tasks. Based on the one or more updated tasks, the asset entity inheritance system 302 can also reconfigure the digital asset template for the first asset.

In certain embodiments, the asset entity inheritance system 302 can determine one or more measurement points for the one or more asset tasks associated with the first asset based on the asset category. Additionally, the asset entity inheritance system 302 can cause rendering of data associated with the one or more measurement points via the electronic interface. In certain embodiments, the asset entity inheritance system 302 can apply a respective operational limit to the one or more measurement points associated with the first asset based on the asset category. certain embodiments, the asset entity inheritance system 302 can apply a respective operational limit to the one or more measurement points associated with the first asset based on the asset inheritance identifier.

In certain embodiments, the asset entity inheritance system 302 can determine a new asset task for the second asset. The asset entity inheritance system 302 can also update the one or more asset tasks associated with the asset category to generate one or more updated asset tasks. In certain embodiments, the asset entity inheritance system 302 can also reconfigure the digital asset template for the first asset based on the one or more updated tasks.

In certain embodiments, the asset entity inheritance system 302 can determine an operational limit for the asset task based on the digital asset template. The asset entity inheritance system 302 can also compare the captured parameter value to the operational limit for the asset task. Based on the comparison of the captured parameter value and the operational limit, the asset entity inheritance system 302 can also determine whether the captured parameter value exceeds the operational limit. In certain embodiments, the asset entity inheritance system 302 can also trigger one or more actions associated with an industrial process related to the first asset upon a determination that the operational limit is exceeded. In various embodiments, the asset entity inheritance system 302 can additionally or alternatively configure one or more industrial processes related to the first asset based at least in part on the digital asset template.

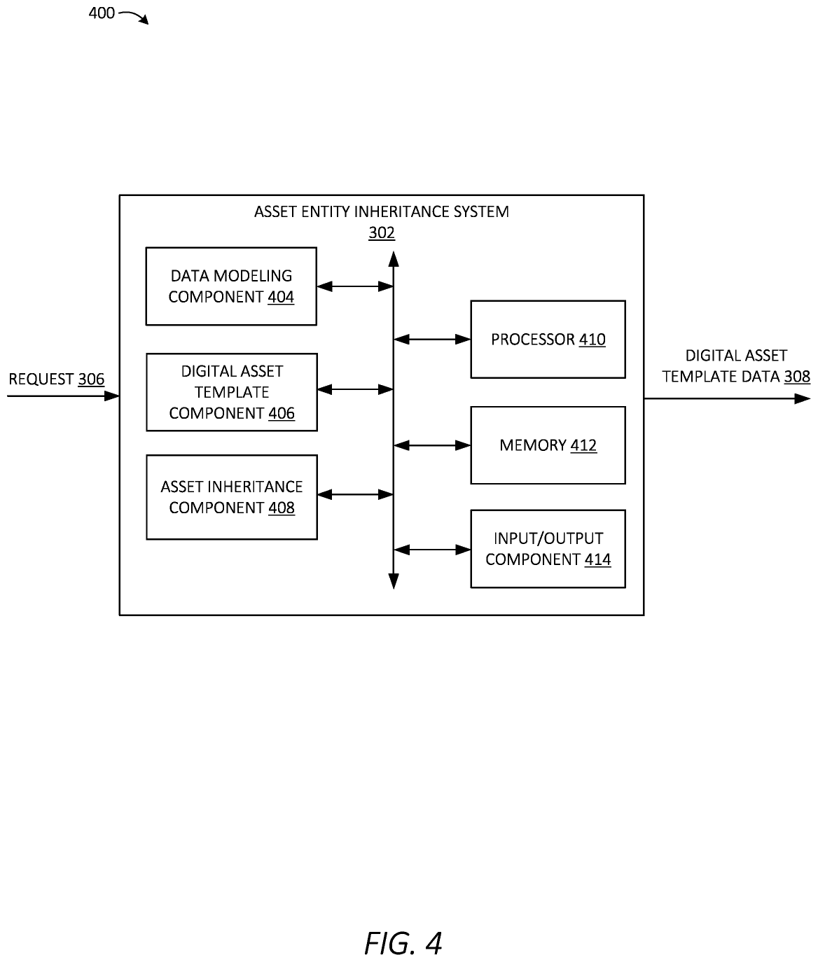

FIG. 4 illustrates a system 400 that provides an exemplary environment according to one or more described features of one or more embodiments of the disclosure. Specifically, the system 400 details the exemplary asset entity inheritance system 302 (first introduced in FIG. 3) to provide a practical application of data modeling and inheritance conventions to support asset entity instance inheritance for one or more industrial assets in an industrial environment. In various embodiments, the asset entity inheritance system 302 provides a practical application of data analytics technology and/or digital transformation technology to facilitate configuration of digital asset templates and corresponding digital asset instances. In one or more embodiments, the asset entity inheritance system 302 provides a practical application of receiving requests to generate digital asset templates, digital asset instances, and/or inspection round checklists associated with a particular industrial environment and transmitting digital asset template data (e.g., digital asset template data 308) comprising visual representations of said digital asset templates, digital asset instances, and/or inspection round checklists.

In an embodiment, the asset entity inheritance system 302 works in conjunction with a server system (e.g., a server device such as asset entity database 304), one or more data sources, and/or one or more assets associated with an industrial environment. In one or more embodiments, the asset entity inheritance system 302 comprises one or more processors and a memory. In one or more embodiments, the asset entity inheritance system 302 interacts with a computer system from the computer systems 120 to facilitate data modeling and asset entity inheritance conventions in accordance with the present disclosure. In various embodiments, the asset entity inheritance system 302 is to, among other things, generate one or more digital asset templates, one or more asset categories, one or more digital asset instances, and/or one or more inspection round checklists related to one or more respective physical assets in the industrial environment. In one or more embodiments, the asset entity inheritance system 302 interacts with a computer system from the computer systems 120 via the network 110. The asset entity inheritance system 302 is also related to one or more technologies, such as, for example, enterprise technologies, industrial technologies, connected building technologies, Internet of Things (IoT) technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies.

Moreover, the asset entity inheritance system 302 provides an improvement to one or more technologies such as enterprise technologies, industrial technologies, connected building technologies, IoT technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies. In an implementation, the asset entity inheritance system 302 improves performance of a user computing device. For example, in one or more embodiments, the asset entity inheritance system 302 improves processing efficiency of a user computing device, reduces power consumption of a computing device, improves quality of data provided by a user computing device, etc. In various embodiments, the asset entity inheritance system 302 improves performance of a user computing device by optimizing content rendered via an interactive user interface, by reducing a number of user interactions with respect to an interactive user interface, and/or by reducing a number of computing resources required to render content via an interactive user interface.

The asset entity inheritance system 302 includes a data modeling component 404, an asset inheritance component 408, and/or a digital asset template component 406. Additionally, in one or more embodiments, the asset entity inheritance system 302 includes a processor 410, a memory 412, and/or an input/output component 414. In certain embodiments, one or more aspects of the asset entity inheritance system 302 (and/or other systems, apparatuses and/or processes disclosed herein) constitute executable instructions embodied within a computer-readable storage medium (e.g., the memory 412). For instance, in an embodiment, the memory 412 stores computer executable component and/or executable instructions (e.g., program instructions). Furthermore, the processor 410 facilitates execution of the computer executable components and/or the executable instructions (e.g., the program instructions). In an example embodiment, the processor 410 is configured to execute instructions stored in the memory 412 or otherwise accessible to the processor 410.

The processor 410 is a hardware entity (e.g., physically embodied in circuitry) capable of performing operations according to one or more embodiments of the disclosure. Alternatively, in an embodiment where the processor 410 is embodied as an executor of software instructions, the software instructions configure the processor 410 to perform one or more algorithms and/or operations described herein in response to the software instructions being executed. In an embodiment, the processor 410 is a single core processor, a multi-core processor, multiple processors internal to the asset entity inheritance system 302, a remote processor (e.g., a processor implemented on a server), and/or a virtual machine. In certain embodiments, the processor 410 is in communication with the memory 412, the data modeling component 404, the asset inheritance component 408, and/or the digital asset template component 406 via a bus to, for example, facilitate transmission of data among the processor 410, the memory 412, the input/output component 414, the data modeling component 404, the asset inheritance component 408, and/or the digital asset template component 406. The processor 410 may be embodied in a number of different ways and, in certain embodiments, includes one or more processing devices configured to perform independently. Additionally or alternatively, in one or more embodiments, the processor 410 includes one or more processors configured in tandem via a bus to enable independent execution of instructions, pipelining of data, and/or multi-thread execution of instructions.

The memory 412 is non-transitory and includes, for example, one or more volatile memories and/or one or more non-volatile memories. In other words, in one or more embodiments, the memory 412 is an electronic storage device (e.g., a computer-readable storage medium). The memory 412 is configured to store information, data, content, one or more applications, one or more instructions, or the like, to enable asset entity inheritance system 302 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

In one or more embodiments, the input/output component 414 is configured to receive a request 306 (e.g., such as from user computing device system 303). In various embodiments, the input/output component 414 can relay the request 306 to the data modeling component 404, the asset inheritance component 408, and/or the digital asset template component 406 for processing and/or compiling digital asset template data 308. Once the digital asset template data 308 has been compiled (e.g., as by the data modeling component 404, the asset inheritance component 408, and/or the digital asset template component 406), the input/output component 414 can transmit the digital asset template data 308 to one or more user computing device system(s) 502. In one or more embodiments, the request 306 received by the asset entity inheritance system 302 (e.g., by way of the input/output component 414) can include one or more asset descriptors that describe a particular type of one or more physical industrial assets. For instance, in one or more embodiments, the request 306 includes one or more asset descriptors that describe the edge devices 161a-161n in order to generate a digital asset template associated with a particular type of asset comprised in the edge devices 161a-161n. An asset descriptor includes, for example, asset properties such as an asset name, an asset inheritance identifier, an asset level and/or asset tasks and category tasks related to operational functionalities such as the industrial process associated with the industrial asset, as well as one or more measurement points the asset is capable of capturing values for.

In various embodiments, the data modeling component 404, the asset inheritance component 408, and the digital asset template component 406 embody executable computer program code and/or interface with one or more computer programs and/or computer hardware configured to employ data modeling and inheritance conventions to support digital asset instance inheritance for one or more industrial assets related to one or more industrial processes in an industrial environment. In various embodiments, the one or more industrial processes are related to the edge devices 161a-161n (e.g., the edge devices 161a-161n included in a portfolio of assets). In one or more embodiments, the edge devices 161a-161n are associated with the portfolio of assets. For instance, in one or more embodiments, the edge devices 161a-161n include one or more assets in a portfolio of assets. The edge devices 161a-161n include, in one or more embodiments, one or more databases, one or more assets (e.g., one or more building assets, one or more industrial assets, etc.), one or more IoT devices (e.g., one or more industrial IoT devices), one or more connected building assets, one or more sensors, one or more actuators, one or more processors, one or more computers, one or more valves, one or more pumps (e.g., one or more centrifugal pumps, etc.), one or more motors, one or more compressors, one or more turbines, one or more ducts, one or more heaters, one or more chillers, one or more coolers, one or more boilers, one or more furnaces, one or more heat exchangers, one or more fans, one or more blowers, one or more conveyor belts, one or more vehicle components, one or more cameras, one or more displays, one or more security components, one or more air handler units, one or more HVAC components, industrial equipment, factory equipment, and/or one or more other devices that are connected to the network 110 for collecting, sending, and/or receiving information. In one or more embodiments, the edge device 161a-161n include, or is otherwise in communication with, one or more controllers for selectively controlling a respective edge device 161a-161n and/or for sending/receiving information between the edge devices 161a-161n and an asset entity inheritance system via the network 110. In one or more embodiments, the edge devices 161a-161n are associated with an industrial environment (e.g., a plant, etc.). Additionally or alternatively, in one or more embodiments, the edge devices 161a-161n are associated with components of the edge 115 such as, for example, one or more enterprises 160a-160n.

In one or more embodiments, the data modeling component 404 can aggregate the data associated with the edge devices 161a-161n from the edge devices 161a-161n. For instance, in one or more embodiments, the data modeling component 404 aggregates the data related to the digital asset templates and digital asset instances associated with the edge devices 161a-161n into an asset entity database 304. Additionally, in one or more embodiments, the data modeling component 404 stores new data and/or modified data related to the digital asset templates and digital asset instances associated with the edge devices 161a-161n in the asset entity database 304. In one or more embodiments, the asset entity inheritance system 302 repeatedly scans the edge devices 161a-161n to determine new data for storage in the asset entity database 304. In one or more embodiments, the data modeling component 404 formats one or more portions of the data associated with the edge devices 161a-161n. For instance, in one or more embodiments, the data modeling component 404 provides a formatted version of the data related to the digital asset templates and digital asset instances associated with the edge devices 161a-161n to the asset entity database 304. In an embodiment, the formatted version of the industrial asset data is formatted with one or more defined formats associated with the one or more intervals of time and/or the one or more asset hierarchy levels. A defined format is, for example, a structure for data fields associated with the digital asset templates and digital asset instances comprised in the asset entity database 304. In one or more embodiments, any time a new digital asset template is created (e.g., by the digital asset template component 406) or a digital asset instance derived from a digital asset template (e.g., by the asset inheritance component 408), the data modeling component 404 updates the asset entity database 304 accordingly.

In various embodiments, the digital asset template component 406 can generate one or more digital asset template associated with one or more respective, particular types of physical assets (e.g., edge devices 161a-161n) employed in a particular industrial environment in response to a request 306. In one or more embodiments, the digital asset template component 406, in response to the request 306, can initialize the one or more digital asset templates associated with the one or more respective, particular types of industrial asset in a server system associated with the particular industrial environment (e.g., in asset entity database 304). In various embodiments, the server system associated with the particular industrial environment can integrate with, or be embodied by, the asset entity database 304.

In various embodiments, the digital asset template component 406 can define a digital asset template to have one or more properties associated with various characteristics of the particular type of physical industrial asset associated with the digital asset template. Additionally, the asset entity inheritance system 302 can associate one or more asset tasks to the digital asset template, where the asset tasks are related to one or more operational functionalities and/or measurement points of the particular type of physical industrial asset associated with the digital asset template. In various embodiments, the digital asset template component 406 can assign the digital asset template to one or more asset categories where the one or more asset categories comprise one or more category tasks, where the one or more category tasks are associated with a physical activity to be performed on the particular type of physical asset associated with the digital asset template, and where the digital asset template inherits the one or more category tasks from the asset category.

In one or more embodiments, the asset inheritance component 408 can generate one or more digital asset instances, where the one or more digital asset instances are data objects derived from a digital asset template. In various embodiments, the one or more digital asset instances inherit the one or more asset tasks and the one or more category tasks from the digital asset template. In one or more embodiments, the asset inheritance component 408 can associate the one or more digital asset instances with one or more respective physical assets in the industrial environment. In one or more embodiments, the asset inheritance component 408 can direct the data modeling component 404 to store the one or more digital asset instances in the asset entity database 304. Additionally, the asset inheritance component 408 is configured to generate an inspection round checklist. In one or more embodiments, the asset inheritance component 408 is configured to prioritize actions and/or tasks related to an inspection round checklist, where an inspection round checklist is a series of one or more operational steps related to a scheduled inspection round to be carried out by an industrial plant operator.

In one or more embodiments, the asset entity inheritance system 302 can configure digital asset template data 308 based on one or more digital asset templates, one or more digital asset instance identifiers, one or more asset descriptors, and/or one or more user identifiers. Additionally, in one or more embodiments, the digital asset template data 308 is configured based on one or more asset tasks and/or one or more properties associated with one or more digital asset templates. Additionally or alternatively, in one or more embodiments, the digital asset template data 308 is configured based on one or more asset tasks and/or one or more properties associated with one or more digital asset instances. In various embodiments, the digital asset template data 308 is configured based on one or more asset categories, and/or the one or more category tasks associated with the one or more asset categories. In one or more embodiments, the input/output component 414 is configured to facilitate transmitting the digital asset template data 308 to one or more user computing device system(s) 502.

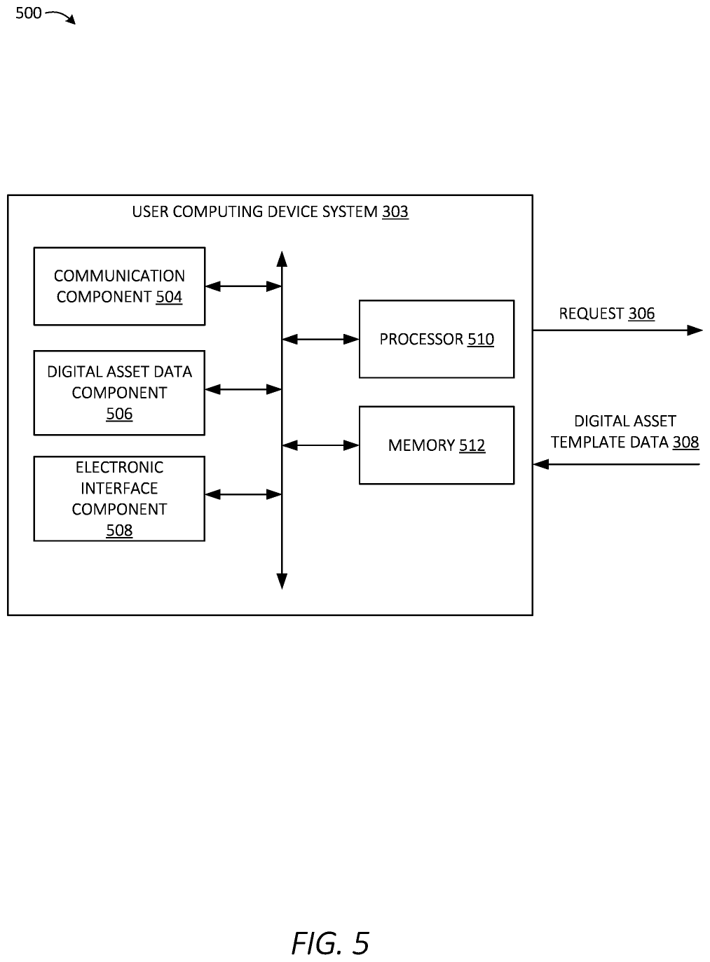

FIG. 5 illustrates a system 500 that provides an exemplary environment according to one or more described features of one or more embodiments of the disclosure. According to an embodiment, the system 500 includes a user computing device system 303 to provide a practical application of data modeling and inheritance conventions to support digital asset instance inheritance for one or more industrial assets in an industrial environment. In various embodiments, the user computing device system 303 provides a practical application of data analytics technology and/or digital transformation technology to facilitate configuration of digital asset templates and corresponding digital asset instances. In one or more embodiments, the user computing device system 303 provides a practical application of sending requests to generate digital asset templates, digital asset instances, and/or inspection round checklists associated with a particular industrial environment and rendering digital asset template data (e.g., digital asset template data 308) comprising visual representations of said digital asset templates, digital asset instances, and/or inspection round checklists.

In an embodiment, the user computing device system 303 facilitates interaction with an asset entity inheritance system associated with a server system (e.g., a server device such as asset entity database 304), one or more data sources, and/or one or more assets associated with an industrial environment. In one or more embodiments, the user computing device system 303 is a device with one or more processors and a memory. In one or more embodiments, the user computing device system 303 interacts with a computer system from the computer systems 120 to facilitate providing an interactive user interface associated with data modeling and asset entity inheritance conventions. In various embodiments, the interactive user interface is configured via the electronic interface component 508 as a dashboard visualization associated with generating one or more digital asset templates, one or more asset categories, one or more digital asset instances, and/or one or more inspection round checklists related to one or more respective physical assets in the industrial environment. In one or more embodiments, the user computing device system 303 interacts with a computer system from the computer systems 120 via the network 110.

Moreover, the user computing device system 303 provides an improvement to one or more technologies such as enterprise technologies, industrial technologies, connected building technologies, IoT technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies. In an implementation, the user computing device system 303 improves performance of a user computing device. For example, in one or more embodiments, the user computing device system 303 improves processing efficiency of a user computing device, reduces power consumption of a computing device, improves quality of data provided by a user computing device, etc. In various embodiments, the user computing device system 303 improves performance of a user computing device by optimizing content rendered via an interactive user interface, by reducing a number of user interactions with respect to an interactive user interface, and/or by reducing a number of computing resources required to render content via an interactive user interface.

The user computing device system 303 includes a communication component 504, a digital asset data component 506, and/or an electronic interface component 508. Additionally, in one or more embodiments, the user computing device system 303 includes a processor 510 and/or a memory 512. In certain embodiments, one or more aspects of the user computing device system 303 (and/or other systems, apparatuses and/or processes disclosed herein) constitute executable instructions embodied within a computer-readable storage medium (e.g., the memory 512). For instance, in an embodiment, the memory 512 stores computer executable component and/or executable instructions (e.g., program instructions). Furthermore, the processor 510 facilitates execution of the computer executable components and/or the executable instructions (e.g., the program instructions). In an example embodiment, the processor 510 is configured to execute instructions stored in the memory 512 or otherwise accessible to the processor 510.

The processor 510 is a hardware entity (e.g., physically embodied in circuitry) capable of performing operations according to one or more embodiments of the disclosure. Alternatively, in an embodiment where the processor 510 is embodied as an executor of software instructions, the software instructions configure the processor 510 to perform one or more algorithms and/or operations described herein in response to the software instructions being executed. In an embodiment, the processor 510 is a single core processor, a multi-core processor, multiple processors internal to the user computing device system 303, a remote processor (e.g., a processor implemented on a server), and/or a virtual machine. In certain embodiments, the processor 510 is in communication with the memory 512, the communication component 504, the digital asset data component 506 and/or the electronic interface component 508 via a bus to, for example, facilitate transmission of data among the processor 510, the memory 512, the communication component 504, the digital asset data component 506, and/or electronic interface component 508. The processor 510 may be embodied in a number of different ways and, in certain embodiments, includes one or more processing devices configured to perform independently. Additionally or alternatively, in one or more embodiments, the processor 510 includes one or more processors configured in tandem via a bus to enable independent execution of instructions, pipelining of data, and/or multi-thread execution of instructions.

The memory 512 is non-transitory and includes, for example, one or more volatile memories and/or one or more non-volatile memories. In other words, in one or more embodiments, the memory 512 is an electronic storage device (e.g., a computer-readable storage medium). The memory 512 is configured to store information, data, content, one or more applications, one or more instructions, or the like, to enable the user computing device system 303 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

In one or more embodiments, the communication component 504 is configured to generate the request 306. In various embodiments, the request 306 is a request to generate one or more digital asset templates, one or more asset categories, one or more digital asset instances, and/or one or more inspection round checklists associated with a particular industrial environment. In various embodiments, the communication component 504 generates the request 306 in response to an action performed with respect to a user interface configuration for an interactive user interface rendered on a visual display via the electronic interface component 508. The action can be, for example, initiating execution of an application (e.g., a mobile application) via a user computing device that presents the interactive user interface, altering an interactive graphical element via the interactive user interface, or another type of action with respect to the interactive user interface rendered via the electronic interface component 508. Additionally or alternatively, in one or more embodiments, the communication component 504 generates the request 306 in response to execution of a user authentication process via a user computing device. For example, in an embodiment, the user authentication process is associated with password entry, facial recognition, biometric recognition, security key exchange, and/or another security technique associated with a user computing device.

In various embodiments, the interactive user interface is a dashboard visualization related to data modeling and inheritance conventions to support digital asset instance inheritance for one or more industrial assets related to one or more industrial processes in an industrial environment. In various embodiments, the one or more industrial processes are related to the edge devices 161a-161n (e.g., the edge devices 161a-161n included in a portfolio of assets). In one or more embodiments, the edge devices 161a-161n are associated with the portfolio of assets. For instance, in one or more embodiments, the edge devices 161a-161n include one or more assets in a portfolio of assets. The edge devices 161a-161n include, in one or more embodiments, one or more databases, one or more assets (e.g., one or more building assets, one or more industrial assets, etc.), one or more IoT devices (e.g., one or more industrial IoT devices), one or more connected building assets, one or more sensors, one or more actuators, one or more processors, one or more computers, one or more valves, one or more pumps (e.g., one or more centrifugal pumps, etc.), one or more motors, one or more compressors, one or more turbines, one or more ducts, one or more heaters, one or more chillers, one or more coolers, one or more boilers, one or more furnaces, one or more heat exchangers, one or more fans, one or more blowers, one or more conveyor belts, one or more vehicle components, one or more cameras, one or more displays, one or more security components, one or more air handler units, one or more HVAC components, industrial equipment, factory equipment, and/or one or more other devices that are connected to the network 110 for collecting, sending, and/or receiving information. In one or more embodiments, the edge device 161a-161n include, or is otherwise in communication with, one or more controllers for selectively controlling a respective edge device 161a-161n and/or for sending/receiving information between the edge devices 161a-161n and an asset entity inheritance system via the network 110. In one or more embodiments, the edge devices 161a-161n are associated with an industrial environment (e.g., a plant, etc.). Additionally or alternatively, in one or more embodiments, the edge devices 161a-161n are associated with components of the edge 115 such as, for example, one or more enterprises 160a-160n.

In one or more embodiments, the request 306 includes one or more asset descriptors that describe a particular type of one or more physical industrial assets. For instance, in one or more embodiments, the request 306 includes one or more asset descriptors that describe the edge devices 161a-161n in order to generate a digital asset template associated with a particular type of asset comprised in the edge devices 161a-161n. An asset descriptor includes, for example, asset properties such as an asset name, an asset inheritance identifier, an asset level and/or operational functionalities such as the industrial process associated with the asset as well as one or more measurement points the asset is capable of capturing values for. Additionally or alternatively, in one or more embodiments, the request 306 includes one or more asset tasks associated with the particular type of asset, such as physical activities associated with the operational functionalities and/or measurement points related to the particular type of asset. Additionally or alternatively, in one or more embodiments, the request 306 includes a particular asset category and one or more category tasks associated with the particular asset category. In various embodiments, the request 306 comprises a request to assign one or more digital asset templates to one or more relevant asset categories. In one or more embodiments, the request 306 comprises a request to generate one or more digital asset instances derived from a digital asset template.

In an embodiment, the communication component 504 is configured to transmit the request 306. In one or more embodiments, the communication component 504 transmits the request 306 to a server system. For example, in one or more embodiments, the communication component 504 transmits the request 306 to an asset entity inheritance system (e.g., asset entity inheritance system 302). In one or more embodiments, the communication component 504 transmits the request 306 to a computer system from the computer systems 120 to facilitate altering configuration of the interactive user interface. In one or more embodiments, the communication component 504 transmits the request 306 via the network 110.

In one or more embodiments, in response to the request 306, the communication component 504 and/or the digital asset data component 506 is configured to receive digital asset template data 308. In one or more embodiments, the digital asset data component 506 receives the digital asset template data 308 from the server system. For example, in one or more embodiments, the digital asset data component 506 receives the digital asset template data 308 from an asset entity inheritance system (e.g., asset entity inheritance system 302). In one or more embodiments, the digital asset data component 506 receives the digital asset template data 308 from a computer system from the computer systems 120 to facilitate altering configuration of the interactive user interface based on the digital asset template data 308. In one or more embodiments, the communication component 504 and/or the digital asset data component 506 receives the digital asset template data 308 via the network 110. In certain embodiments, the communication component 504 and/or the digital asset data component 506 incorporates encryption capabilities to facilitate encryption and/or decryption of one or more portions of the digital asset template data 308. In one or more embodiments, the network 110 is a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, and/or another type of network.

In one or more embodiments, the digital asset template data 308 is configured based on one or more digital asset templates, one or more asset inheritance identifiers, one or more asset descriptors, and/or one or more user identifiers. Additionally, in one or more embodiments, the digital asset template data 308 is configured based on one or more asset tasks and/or one or more properties associated with one or more digital asset templates. Additionally or alternatively, in one or more embodiments, the digital asset template data 308 is configured based on one or more asset tasks and/or one or more properties associated with one or more digital asset instances. In various embodiments, the digital asset template data 308 is configured based on one or more asset categories, and/or the one or more category tasks associated with the one or more asset categories. In one or more embodiments, the communication component 504 and/or the digital asset data component 506 is configured to interface with the server system (e.g., the asset entity inheritance system 302) to facilitate receiving the digital asset template data 308.

In one or more embodiments, the digital asset data component 506 is configured to render an inspection round checklist via an interactive user interface (e.g., on the electronic interface component 508). In one or more embodiments, the interactive user interface is configured as a dashboard visualization rendered via a display of a user computing device. In one or more embodiments, the interactive user interface is associated with the edge devices 161a-161n (e.g., the edge devices 161a-161n included in a portfolio of assets). In one or more embodiments, the interactive user interface is configured to provide prioritized actions related to an inspection round checklist, where an inspection round checklist is a series of one or more operational steps related to a scheduled inspection round to be carried out by an industrial plant operator. In one or more embodiments, the digital asset data component 506 renders (e.g., by way of the electronic interface component 508) the inspection round checklist as respective interactive display elements on the interactive user interface. An interactive display element is a portion of the interactive user interface (e.g., a user-interactive electronic interface portion) that provides interaction with respect to a user of the user computing device. For example, in one or more embodiments, an interactive display element is an interactive display element associated with a set of pixels that allows a user to provide feedback and/or to perform one or more actions with respect to the interactive user interface. In an embodiment, in response to interaction with an interactive display element, the interactive user interface is dynamically altered to display one or more altered portions of the interactive user interface associated with different visual data and/or different interactive display elements.

Additionally, in one or more embodiments, the electronic interface component 508 is configured to facilitate execution and/or initiation of one or more actions via the dashboard visualization based on the digital asset template data 308. In an embodiment, an action is executed and/or initiated via an interactive display element of the dashboard visualization. In certain embodiments, the interactive user interface presents one or more notifications associated with the prioritized actions related to the digital asset template data 308 (e.g., an inspection round checklist). In certain embodiments, the digital asset template data 308 includes one or more inspection round checklist tasks associated with one or more asset tasks and/or one or more category tasks associated with one or more digital asset instances in a particular industrial environment. In certain embodiments, an action related to an interactive display element of the interactive user interface includes an action associated with the application services layer 225, the applications layer 230, and/or the core services layer 235.

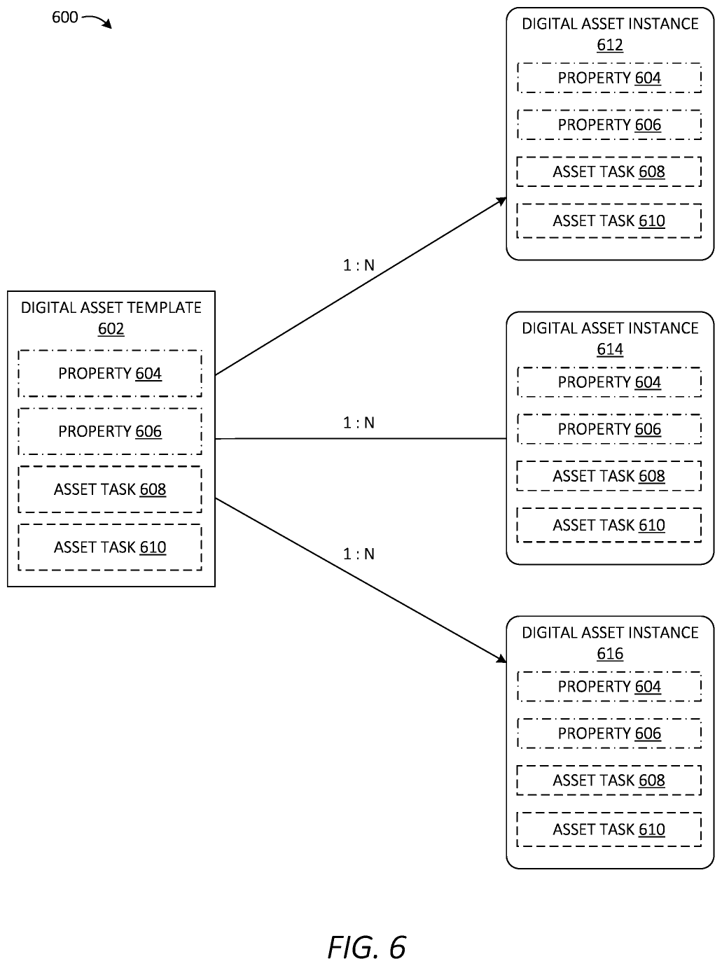

FIG. 6 illustrates a data flow diagram for generating multiple digital asset instances derived from a digital asset template, in accordance with one or more embodiments described herein. Specifically, FIG. 6 illustrates the one-to-many relationship possible between a digital asset template (e.g., digital asset template 602) and one or more digital asset instances (e.g., digital asset instance 612, 614, and 616 respectively. In one or more embodiments, in response to a request 306 made to an exemplary asset entity inheritance system (e.g., asset entity inheritance system 302), the asset entity inheritance system can generate one or more digital asset instances associated with one or more respective physical assets employed in a particular industrial environment. In various embodiments, a digital asset template 602 can be defined to have one or more properties (e.g., properties 604 and 606) associated with various characteristics and/or one or more asset tasks (e.g., asset tasks 608 and 610) associated with one or more operational functionalities and/or measurement points of the particular type of physical industrial asset associated with the digital asset template 602. In various embodiments, one or more industrial processes related to one or more assets can be based at least in part on the digital asset template 602. For example, one or more parameters for one or more industrial processes related to one or more assets can be configured based at least in part on the digital asset template 602.

For example, in one or more embodiments, digital asset template 602 can have property 604 and property 606 associated with various characteristics of the particular type of physical asset with which the digital asset template 602 is associated. In one or more embodiments, properties associated with a digital asset template can be single-value or multi-value properties. In one or more embodiments, one or more properties associated with a digital asset template (e.g., digital asset template 602) can correspond to one or more particular data types associated with particular types of parameter values (e.g., integer values, string values, Boolean values, floating decimal values, and/or collections such as arrays). For example, a digital asset template 602 can comprise property 604 and property 606 and can be associated with a particular type of atmospheric pump that embodies a particular set of properties. For instance, property 604 can be a single-value property associated with digital asset template 602, where property 604 can be associated with the name of the atmospheric pump for which digital asset template 602 is associated. Continuing the example, property 606 can be a multi-value property associated with digital asset template 602, where property 606 can be associated with the various running modes (e.g., “running,” “idle,” or “stopped) of the atmospheric pump for which digital asset template 602 is associated.

In one or more embodiments, digital asset template 602 can be associated with one or more asset tasks (e.g., asset tasks 608 and 610), where an asset task is a data object associated with a physical activity to be performed on, or by, the particular type of physical asset associated with the digital asset template 602. In one or more embodiments, an asset task corresponds to an operational functionality and/or a measurement point associated with the particular type of physical asset with which the digital asset template 602 is associated. For example, a particular type of physical asset related to a particular industrial process in an industrial environment (e.g., such as a particular type of fluid pump) may have one or more operational functionalities related to the industrial process with which the particular type of physical asset is associated. In the case of the particular type of fluid pump, the fluid pump may be capable of starting flow, stopping flow, adjusting one or more valves, capturing a pressure measurement, capturing a temperature measurement, and/or the like. For example, in various embodiments, digital asset template 602 may be associated with the particular type of fluid pump and the corresponding asset task 608 may be associated with capturing a temperature value of the fluid contents passing through the fluid pump. Similarly, asset task 610 associated with the digital asset template 602 may be associated with capturing a pressure value related to the fluid contents passing through the fluid pump.

In one or more embodiments, one or more asset tasks (e.g., such as asset tasks 608 and 610) can be automatically performed by the particular type of physical asset with which the digital asset template 602 is associated. In one or more embodiments, the parameter values captured by one or more asset tasks (e.g., such as asset tasks 608 and 610) can be automatically stored in a database (e.g., asset entity database 304) and/or a server system related to a particular industrial environment. Additionally or alternatively, one or more asset tasks (e.g., such as asset tasks 608 and 610) can be manually performed by a human operator on a particular physical asset associated with a digital asset instance (e.g., digital asset instance 612) in the industrial environment and any parameter value captured during execution of the asset task can be manually stored in the asset entity database 304. In one or more embodiments, the request 306 transmitted to the asset entity inheritance system 302 can cause the asset entity inheritance system 302 to generate one or more digital asset instances (e.g., digital asset instances 612, 614, and 616) associated with one or more respective physical assets in a particular industrial environment based on the digital asset template 602.

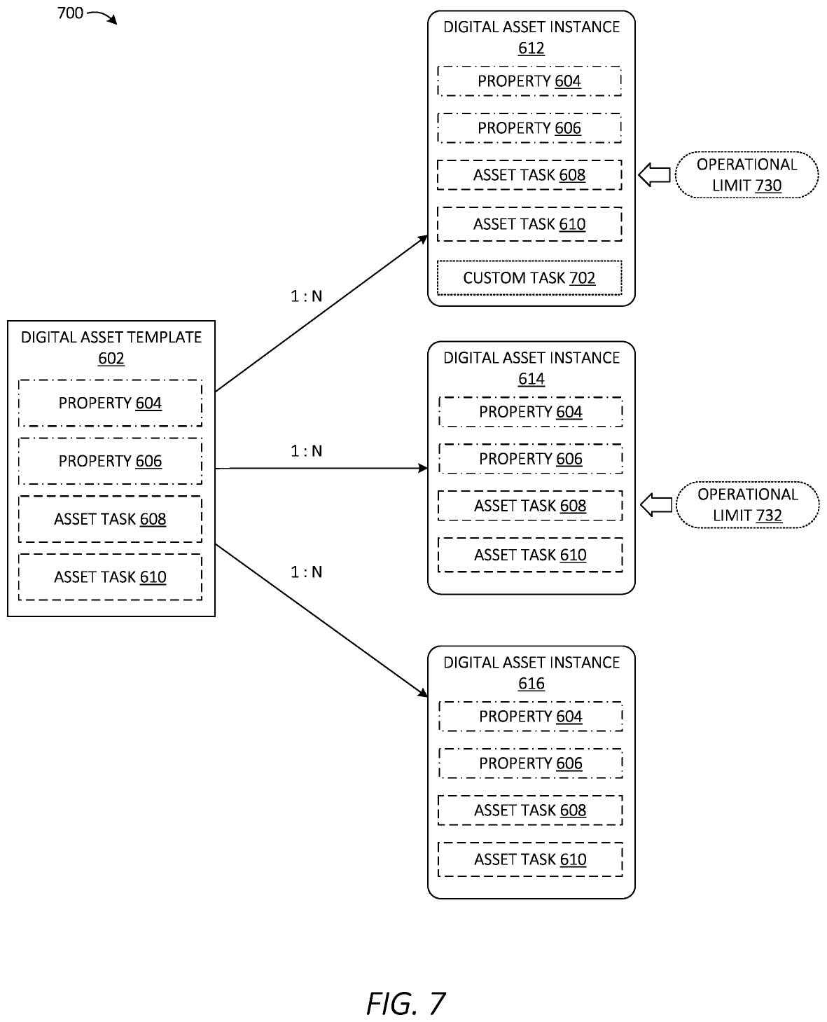

FIG. 7 provides another data flow diagram 700 for generating multiple digital asset instances derived from a digital asset template, in accordance with one or more embodiments described herein. Specifically, FIG. 7 illustrates how an operational limit can be assigned to one or more digital asset instances (e.g., digital asset instances 612 and 614). In one or more embodiments, an operational limit is a minimum or maximum acceptable parameter value related to a particular task associated with a particular digital asset instance, where the particular task can be one of an asset task, a category task, or a custom task associated with the particular digital asset instance.

For example, if a digital asset template (e.g., digital asset template 602) comprises a task related to capturing a pressure measurement, the task will be inherited by one or more digital asset instances derived from the digital asset template. However, an operational limit can be defined for one or more of the digital asset instances such that a different pressure value threshold can be set for the one or more digital asset instances associated with one or more respective physical assets. For instance, digital asset instance 612 and digital asset instance 614 both inherited asset task 608 from digital asset template 602. In this example, digital asset template 602 can be associated with a particular type of physical atmospheric compressor employed in an industrial environment such as, for example, an industrial plant, an industrial processing environment, an industrial manufacturing environment, and/or another type of industrial environment. Likewise, asset task 608 can be associated with capturing a pressure value related to the industrial process with which the digital asset template 602 is associated. In various embodiments, an operational limit 730 can be defined for the digital asset instance 612 as it relates to the respective asset task 608, whereas an operational limit 732 can be defined for the digital asset instance 614 as it relates to the respective asset task 608. In this manner, one or more digital asset instances associated with one or more physical assets in a particular industrial environment can be generated efficiently by inheriting the related tasks and properties associated with the digital asset template from which the digital asset instances are derived. Furthermore, it will be appreciated that after the one or more digital asset instances have been generated, custom operational limits can be configured for individual digital asset instances associated with specific physical assets in the particular industrial environment.

In various embodiments, if an operational limit (e.g., operational limit 730) associated with a particular digital asset instance (e.g., digital asset instance 612) is exceeded, one or more actions can be triggered, thereby altering an industrial process related to the specific physical asset associated with the particular digital asset instance. In various embodiments, the one or more actions triggered by the operational limit can include, but are not limited to, alarm triggers, safety measures, industrial process alterations, and/or any actions related to the protection and safety of any equipment and/or personnel in the particular industrial environment.

In one or more embodiments, a custom task can be defined for a particular digital asset instance. For example, looking back to the atmospheric compressor example from above, one or more digital asset instances can be derived from the digital asset template associated with that particular type of atmospheric compressor and associated with one or more respective atmospheric compressors employed in the particular industrial environment. An individual digital asset instance (e.g., digital asset instance 612) associated with a specific atmospheric compressor can be updated to include one or more custom tasks associated with the specific atmospheric compressor such that the one or more custom tasks are carried out only for that specific atmospheric compressor and not for the other one or more atmospheric compressors associated with the other one or more digital asset instances derived from the same digital asset template. For example, digital asset instance 612 derived from digital asset template 602 can be configured to comprise custom task 702 in addition to the asset tasks 608 and 610 which were derived from the digital asset template 602.

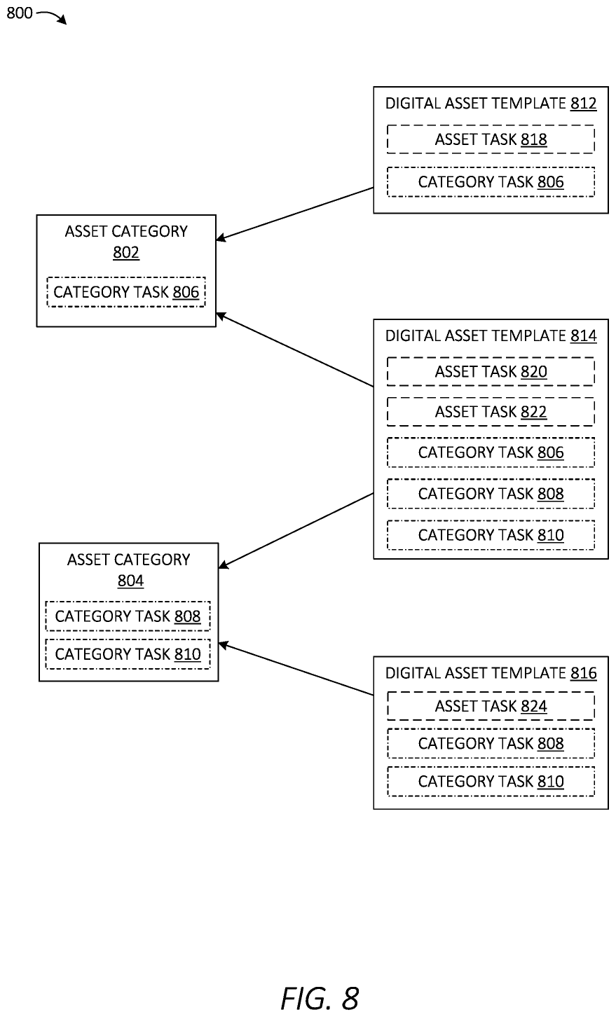

FIG. 8 illustrates a data flow diagram for assigning one or more digital asset templates to one or more asset categories, in accordance with one or more embodiments described herein. Specifically, FIG. 8 illustrates the inheritance relationship between a digital asset template (e.g., digital asset template 814) and one or more asset categories (e.g., asset categories 802 and/or 804). In one or more embodiments, asset categories (e.g., asset categories 802 and 804) comprise one or more category tasks associated with a particular industrial plant management process and/or a particular class of physical asset employed in an industrial environment. For example, the asset entity inheritance system 302 can comprise asset categories such as “maintenance” or “safety” for which particular category tasks can be associated. A maintenance asset category can comprise category tasks such as “check lube” and/or “replace lube,” where a safety asset category can comprise category tasks such as “check safety seal.” Additionally or alternatively, asset categories may encompass various types of physical assets such as “temperature critical assets” and/or “pressurized assets” such that multiple types of digital asset templates (e.g., digital asset templates 812, 814, and 816) associated with multiple types of particular physical assets may be assigned to said asset categories. For example, digital asset templates associated with a fluid pump and a motor can be assigned to both the maintenance asset category and the temperature critical assets asset category such that the respective digital asset templates associated with the fluid pump and the motor will inherit the category tasks associated with said asset categories.

In one or more embodiments, the asset entity inheritance system 302 can receive a request 306 that comprises instructions to assign one or more digital asset templates to one or more asset categories. For example, the asset entity inheritance system 302 can assign one or more digital asset templates to one or more asset categories. For instance, the asset entity inheritance system 302 can assign digital asset template 812 to a single asset category (e.g., asset category 802). Likewise, in various embodiments, the digital asset template 816 can be assigned to a single asset category (e.g., single asset category 804). In one or more embodiments, a digital asset template (e.g., digital asset template 814) can be assigned to multiple asset categories simultaneously. For example, in various embodiments, digital asset template 814 can be assigned to both asset category 802 and asset category 804 respectively.

In one or more embodiments, when the asset entity inheritance system 302 assigns one or more digital asset templates to one or more asset categories, the asset entity inheritance system 302 automatically resolves the inheritance of particular category tasks associated with particular asset categories by the digital asset templates. For example, when digital asset template 812, which previously only comprised the corresponding asset task 818, is assigned to asset category 802, the asset entity inheritance system 302 automatically resolves the inheritance of category task 806 by digital asset template 812. As such, digital asset template 812 now comprises multiple tasks—asset task 818 related to the particular type of physical asset with which the digital asset template 812 is associated, and category task 806 which was automatically inherited when the asset entity inheritance system 302 assigned the digital asset template 812 to the asset category 802. Similarly, the digital asset template 816, which previously only comprised its corresponding asset task 824, automatically inherited category tasks 808 and 810 from asset category 804 when the asset entity inheritance system 302 assigned the digital asset template 816 to the asset category 804.

In one or more embodiments, when a digital asset template (e.g., digital asset template 814) is assigned to multiple asset categories (e.g., asset categories 802 and 804), the asset entity inheritance system 302 automatically resolves the inheritance of the associated category tasks by the digital asset template. For example, digital asset template 814 has been assigned to both asset category 802 and asset category 804, and, as such, the asset entity inheritance system 302 has resolved the inheritance of category task 806 associated with asset category 802, and it has resolved the inheritance of category tasks 808 and 810 associated with asset category 804 for the digital asset template 814. As a result, the digital asset template 814 now comprises its original asset tasks (asset tasks 820 and 822) as well as category tasks 806, 808, and 810 which were inherited from asset categories 802 and 804 respectively.

In one or more embodiments, the asset entity inheritance system 302 is configured such that any updates to the one or more asset categories associated with the asset entity inheritance system 302 are automatically resolved for any digital asset templates associated with the one or more asset categories. For example, the asset entity inheritance system 302 can receive a request 306 to update the asset category 804, where an update can include, but is not limited to, a change to a particular category task (e.g., category task 808), a change to the particular category task's requirements or measurement points, and/or an addition or removal of a category task from the asset category 804. In response to the request 306, the asset entity inheritance system 302 can employ the updates to the asset category 804 and then automatically update the digital asset templates that have been assigned to the asset category 804 (digital asset templates 814 and 816 respectively) to reflect any changes made to the asset category 804. Furthermore, the asset entity inheritance system 302 can automatically update any digital asset instances associated with the digital asset templates 814 and 816 (e.g., digital asset instance 910 and 912 respectively) based on any updates made to the asset category 804 to which the digital asset templates 814 and 816 are assigned.

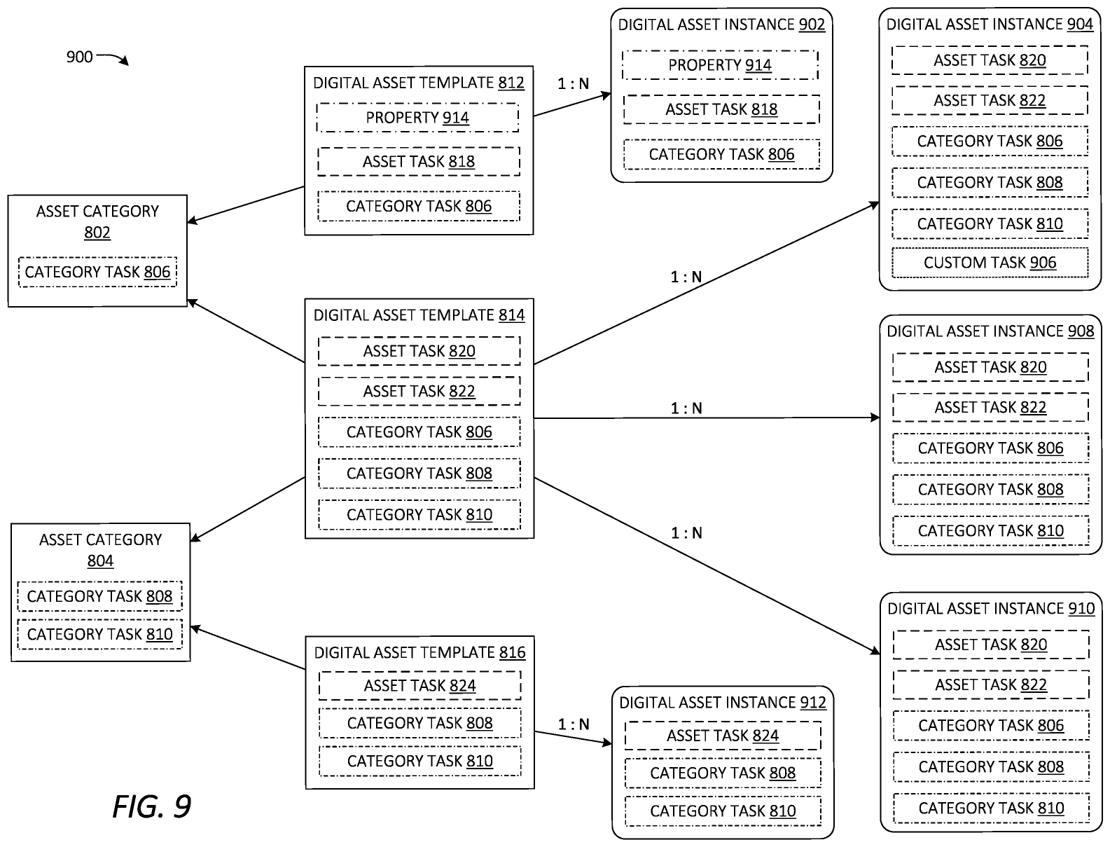

FIG. 9 illustrates a data flow diagram for generating multiple digital asset instances based on one or more digital asset templates, in accordance with one or more embodiments described herein. Specifically, FIG. 9 brings together the concepts described in FIG. 6, FIG. 7, and FIG. 8 to illustrate the data modeling and inheritance conventions of an exemplary asset entity inheritance system. In various embodiments, the asset entity inheritance system 302 can generate one or more digital asset instances (e.g., digital asset instances 902, 904, 908, 910, and 912 respectively) associated with one or more respective physical assets in a particular industrial environment. In one or more embodiments, the asset entity inheritance system 302 resolves the inheritance of any properties, asset tasks, and/or category tasks associated with a respective digital asset template by one or more digital asset instances. For example, the asset entity inheritance system 302 can generate digital asset instance 902 based on the digital asset template 812 which is assigned to asset category 802 and associate it with a particular physical asset in the industrial environment. As such, the digital asset instance 902 comprises property 914, asset task 818, and category task 806 derived from digital asset template 812 and asset category 802 respectively.

In various embodiments, the asset entity inheritance system 302 can generate multiple digital asset instances based on a single digital asset template that has been assigned to multiple asset categories. For example, the asset entity inheritance system 302 can generate digital asset instances 904, 908, and 910 based on the digital asset template 814 which is assigned to asset categories 802 and 804. As such, the digital asset instances 904, 908, and 910 all comprise asset tasks 820 and 822 associated with the particular type of physical asset with which the digital asset template 814 is associated, as well as the category tasks 806, 808, and 810 inherited from asset categories 802 and 804 respectively for which the digital asset template 814 has been assigned. In one or more embodiments, once the asset entity inheritance system 302 has generated a particular digital asset instance (e.g., digital asset instance 904), it can receive a request 306 to define a custom task for that particular digital asset instance. For example, the asset entity inheritance system 302 can define a custom task 906 related to an operational functionality and/or measurement point associated with the particular physical asset with which the digital asset instance 904 is associated and update the digital asset instance 904 to include the custom task 906. As such, none of the other one or more digital asset instances derived from the digital asset template 814 (digital asset instances 908 and 910) will comprise the custom task 906, thereby allowing the asset entity inheritance system 302 to customize particular digital asset instances related to a particular industrial environment.

In one or more embodiments, according to the data modeling and inheritance conventions employed in exemplary systems of the present disclosure, one or more digital asset instances associated with one or more respective digital asset templates can be automatically updated in response to an update of the one or more digital asset templates and/or an update to the one or more asset categories to which the one or more digital asset templates are assigned. In various embodiments, an update to the one or more digital asset templates (e.g., digital asset templates 812, 814, and 816) comprises any change to at least one of the one or more properties associated with the digital asset template (e.g., property 914), the one or more asset tasks associated with the digital asset template (e.g., asset task 818), and/or the one or more category tasks associated with the one or more asset categories to which the digital asset template is assigned (e.g., asset category 802). In certain embodiments, once an update to a digital asset template and/or an asset category is realized, any digital asset instances associated with and/or derived from the digital asset template and/or asset category can be automatically updated in the database and/or server system associated with the particular industrial environment to which the digital asset templates are related.

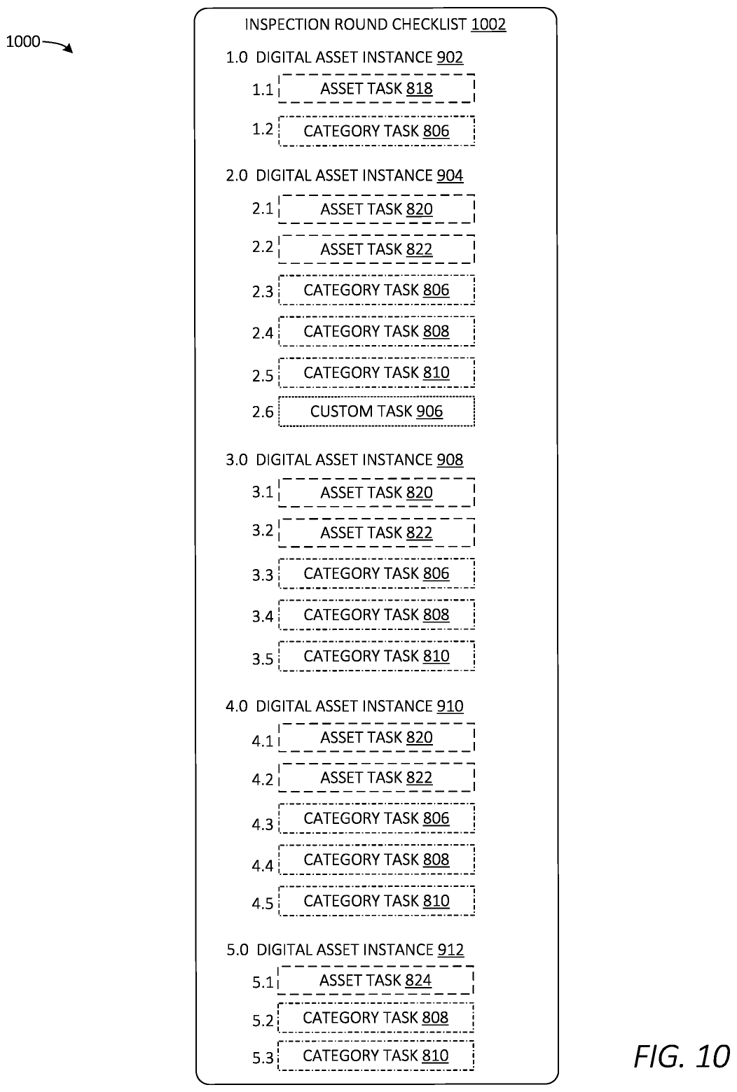

FIG. 10 illustrates an exemplary inspection round checklist generated by an asset entity inheritance system, in accordance with one or more embodiments described herein. In one or more embodiments, the asset entity inheritance system 302 can generate an inspection round checklist (e.g., inspection round checklist 1002) comprising a list of tasks associated with one or more physical assets in a particular industrial environment. In various embodiments, the asset entity inheritance system 302 can compile a list of tasks inherited by one or more digital asset instances (e.g., digital asset instance 902 and 904) from one or more digital asset templates (e.g., digital asset template 812 and 814), as well as any customs tasks defined for any particular digital asset instances (e.g., custom task 906).

In one or more embodiments, the asset entity inheritance system 302 can transmit, via the network 110, the inspection round checklist 1002 to one or more user computing device system(s) 502 associated with the particular industrial environment. In one or more embodiments, the inspection round checklist 1002 can be generated and transmitted to a user computing device system 303 on a schedule (e.g., daily, weekly, monthly, etc.) such that one or more plant operators may perform and/or monitor the tasks in the inspection round checklist 1002 on a routine basis. In one or more embodiments, the one or more tasks comprised by the inspection round checklist 1002 can be prioritized based on various parameters. For instance, the asset entity inheritance system 302 can prioritize the one or more tasks in the inspection round checklist 1002 based on parameters including, but not limited to, the layout of a particular industrial environment, category tasks (e.g., category tasks 806 and/or 808) associated with asset categories related to high priority assets (e.g., assets that can impact plant and personnel safety), and/or any procedural parameters defined by the asset entity inheritance system 302 associated with a particular industrial environment.

It will be appreciated that the inheritance conventions of the asset entity inheritance system 302, as they pertain to generating inspection round checklists (e.g., inspection round checklist 1002), are such that inspection round checklists can be “industrial plant agnostic” in that they are derived from the asset tasks and category tasks comprised in respective digital asset templates. In this regard, if an industrial enterprise maintains multiple industrial environments (e.g., one or more industrial plants) that employ the same types of physical assets (e.g., edge devices 161a-161n), the asset entity inheritance system 302 associated with the multiple industrial environments can employ the same digital asset templates and asset categories across each of the respective industrial environments. This allows the asset entity inheritance system 302 to define the inspection round checklist 1002 that can be re-used in any industrial environment globally. In one or more embodiments, the content of the inspection round checklist 1002 will dynamically be loaded on one or more user computing device system(s) 502 such that one or more plant operators may execute the tasks comprised on the inspection round checklist 1002.

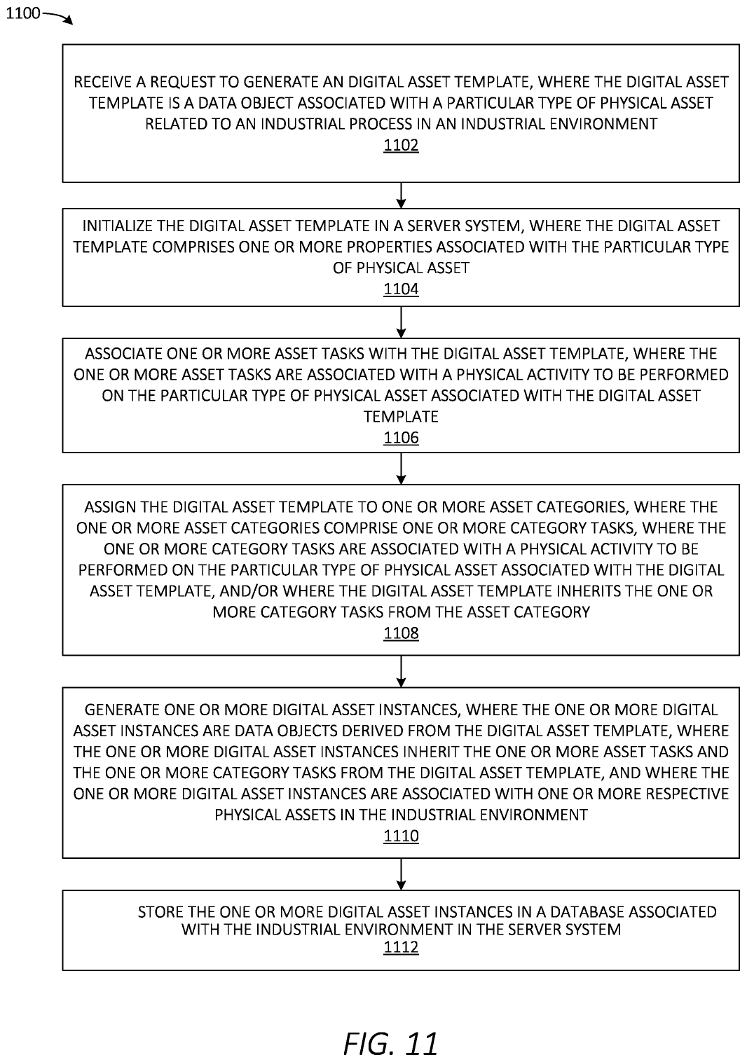

FIG. 11 illustrates a process flow diagram for resolving asset entity inheritance in an asset entity inheritance system, in accordance with one or more embodiments described herein. Specifically, FIG. 11 illustrates a method 1100 for resolving asset entity inheritance for one or more digital asset instances associated with one or more respective physical assets in an industrial environment. In one or more embodiments, the method 1100 is associated with the asset entity inheritance system 302. Additionally or alternatively, in various embodiments, the method 1100 is associated with the user computing device system 303 in conjunction with the asset entity inheritance system 302. In one or more embodiments, the method 1100 begins at step 1102 that receives a request to generate a digital asset template (e.g., the asset entity inheritance system 302 receives the request 306), where the digital asset template (e.g., digital asset template 814) is a data object associated with a particular type of physical asset related to an industrial process in an industrial environment. For instance, the digital asset template 814 can be associated with a particular type of edge device (e.g., one of the edge devices 161a-161n).

The method 1100 also includes a step 1104 in which the asset entity inheritance system 302 initializes the digital asset template (e.g., digital asset template 602) in a server system associated with the industrial environment, where the digital asset template (e.g., digital asset template 602) comprises one or more properties associated with the particular type of physical asset. In various embodiments, the asset entity inheritance system 302 can initialize the digital asset template 602 in the asset entity database 304. In one or more embodiments, properties associated with a digital asset template can be single-value or multi-value properties. In one or more embodiments, one or more properties associated with a digital asset template (e.g., digital asset template 602) can correspond to one or more particular data types associated with particular types of parameter values (e.g., integer values, string values, Boolean values, floating decimal values, and/or collections such as arrays). For example, a digital asset template 602 can comprise property 604 and property 606 and can be associated with a particular type of atmospheric pump that embodies a particular set of properties. For instance, property 604 can be a single-value property associated with digital asset template 602, where property 604 can be associated with the name of the atmospheric pump for which digital asset template 602 is associated. Additionally, property 606 can be a multi-value property associated with digital asset template 602, where property 606 can be associated with the various running modes (e.g., “running,” “idle,” or “stopped) of the atmospheric pump for which digital asset template 602 is associated.

The method 1100 also includes a step 1106 in which the asset entity inheritance system 302 associates one or more asset tasks with the digital asset template (e.g., digital asset template 602), where the one or more asset tasks are associated with a physical activity to be performed on the particular type of physical asset associated with the digital asset template. For example, digital asset template 602 can be associated with asset tasks 608 and 610, where the asset tasks 608 and 610 are data objects associated with a physical activity to be performed on, or by, the particular type of physical asset associated with the digital asset template 602. In one or more embodiments, asset tasks 608 and 610 correspond to an operational functionality and/or a measurement point associated with the particular type of physical asset with which the digital asset template 602 is associated. For example, a particular type of physical asset related to a particular industrial process in an industrial environment (e.g., such as a particular type of fluid pump) may have one or more operational functionalities related to the industrial process with which the particular type of physical asset is associated. In the case of the particular type of fluid pump, the fluid pump may be capable of starting flow, stopping flow, adjusting one or more valves, capturing a pressure measurement, capturing a temperature measurement, and/or the like. For example, in various embodiments, digital asset template 602 may be associated with the particular type of fluid pump and the corresponding asset task 608 may be associated with capturing a temperature value of the fluid contents passing through the fluid pump. Similarly, asset task 610 associated with the digital asset template 602 may be associated with capturing a pressure value related to the fluid contents passing through the fluid pump.

In one or more embodiments, one or more asset tasks (e.g., such as asset tasks 608 and 610) can be automatically performed by the particular type of physical asset with which the digital asset template 602 is associated. In one or more embodiments, the parameter values captured by one or more asset tasks (e.g., such as asset tasks 608 and 610) can be automatically stored in a database (e.g., asset entity database 304) and/or a server system related to a particular industrial environment. Additionally or alternatively, one or more asset tasks (e.g., such as asset tasks 608 and 610) can be manually performed by a human operator on a particular physical asset associated with a digital asset instance (e.g., digital asset instance 612) in the industrial environment and any parameter value captured during execution of the asset task can be manually stored in the asset entity database 304 via the user computing device system 303.

The method 1100 also includes a step 1108 in which the asset entity inheritance system 302 assigns the digital asset template (e.g., digital asset template 814) to one or more asset categories (e.g., asset category 804), where the one or more asset categories comprise one or more category tasks (e.g., category tasks 808 and 810), where the one or more category tasks are associated with a physical activity to be performed on the particular type of physical asset associated with the digital asset template (e.g., digital asset template 814), and/or where the digital asset template inherits the one or more category tasks from the asset category (e.g., the digital asset template 814 inherits category task 806 from asset category 802, and the category tasks 808 and 810 from asset category 804 respectively).

By way of example, in various embodiments, the asset entity inheritance system 302 can comprise asset categories such as “safety” or “maintenance” associated with asset category 802 and asset category 804 respectively. In various embodiments, particular category tasks (e.g., category tasks 806, 808, and 810) can be associated with asset categories 802 and 804 respectively. The safety asset category (associated with asset category 802) can comprise category tasks such as “check safety seal” associated with category task 806, whereas a maintenance asset category (associated with asset category 804) can comprise category tasks such as “check lube” and/or “replace lube” associated with category tasks 808 and 810 respectively. Additionally or alternatively, asset categories may encompass various types of physical assets such as “temperature critical assets” and/or “pressurized assets” such that multiple types of digital asset templates (e.g., digital asset templates 812, 814, and 816) associated with multiple types of particular physical assets may be assigned to said asset categories. For example, digital asset templates associated with a fluid pump and a motor can be assigned to both the maintenance asset category and the temperature critical assets asset category such that the respective digital asset templates associated with the fluid pump and the motor will inherit the category tasks associated with said asset categories.

The method 1100 also includes a step 1110 in which the asset entity inheritance system 302 generates one or more digital asset instances (e.g., digital asset instances 902, 904, 908, 910, and/or 912) associated with one or more respective physical assets in the industrial environment, where the one or more digital asset instances are data objects derived from a digital asset template (e.g., from digital asset templates 812, 814, and/or 816), where the one or more digital asset instances inherit the one or more asset tasks (e.g., asset tasks 818, 820, 822, and/or 824) and the one or more category tasks (e.g., category tasks 806, 808, 810) from the digital asset template (e.g., from digital asset template 814), and/or where the one or more digital asset instances are associated with one or more respective physical assets in the industrial environment. For example, in one or more embodiments, the request 306 transmitted to the asset entity inheritance system 302 can cause the asset entity inheritance system 302 to generate digital asset instances 904, 908, and 910 associated with respective physical assets in a particular industrial environment based on the digital asset template 814. In one or more embodiments, the asset entity inheritance system 302 can resolve the inheritance of asset tasks 820 and 822 and category tasks 806, 808, 810 by the digital asset instances 904, 908, and 910.

The method 1100 also includes a step 1112 in which the asset entity inheritance system 302 stores the one or more digital asset instances (e.g., digital asset instances 904, 908, and 910) in a database (e.g., asset entity database 304) associated with the industrial environment in the server system.

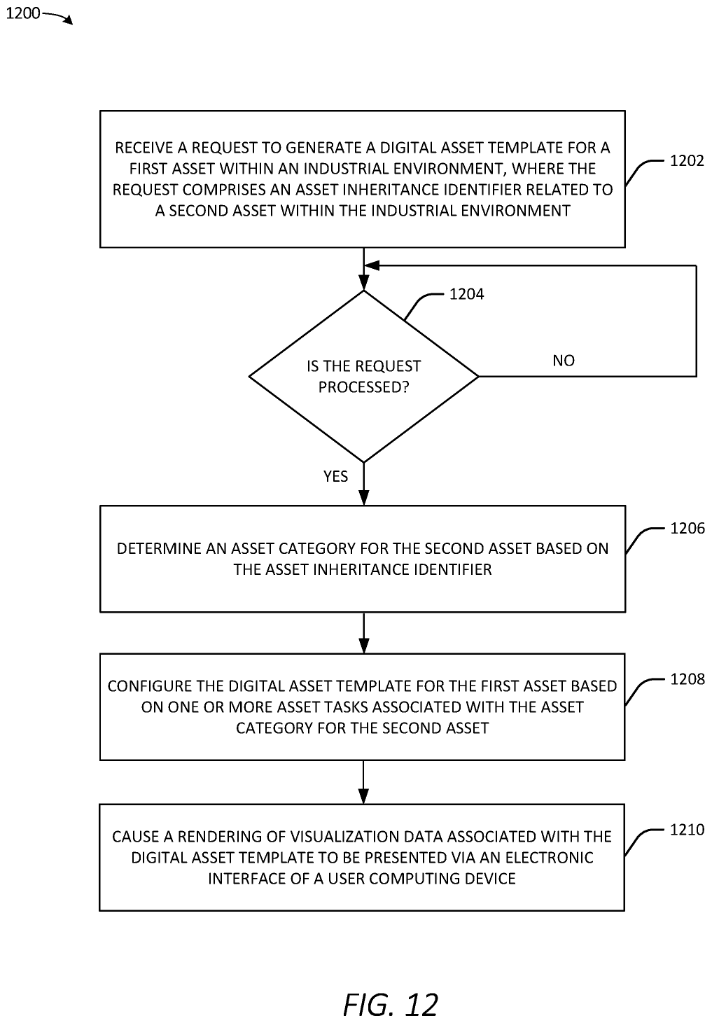

FIG. 12 illustrates a process flow diagram for resolving asset entity inheritance in an asset entity inheritance system, in accordance with one or more embodiments described herein. Specifically, FIG. 12 illustrates a method 1200 for resolving asset entity inheritance for one or more digital asset instances associated with one or more respective physical assets in an industrial environment. In one or more embodiments, the method 1200 is associated with the asset entity inheritance system 302. Additionally or alternatively, in various embodiments, the method 1200 is associated with the user computing device system 303 in conjunction with the asset entity inheritance system 302. In one or more embodiments, the method 1200 begins at step 1202 that receives a request to generate a digital asset template for a first asset within an industrial environment (e.g., the asset entity inheritance system 302 receives the request 306), where the request comprises an asset inheritance identifier related to a second asset within the industrial environment. The request provides one or more technical improvements such as, but not limited to, facilitating interaction with a user computing device and/or extended functionality for a user computing device.

At block 1204, it is determined whether the request is processed. For example, it can be determined whether the server system (e.g., the asset entity inheritance system 302) has processed the request. If no, block 1204 is repeated to determine whether the request is processed. If yes, the method 1200 proceeds to block 1206. In response to the request, the method 1200 includes a block 1206 that determines (e.g., by the digital asset template component 406) an asset category (e.g., asset category 804) for the second asset based on the asset inheritance identifier. In one or more embodiments, the digital asset template inherits the one or more category tasks from the asset category (e.g., the digital asset template 814 inherits category task 806 from asset category 802, and the category tasks 808 and 810 from asset category 804 respectively). The determining the asset category provides one or more technical improvements such as, but not limited to, extended functionality for a user computing device.

In response to the request, the method 1200 also includes a block 1208 that configures (e.g., by the digital asset template component 406) the digital asset template for the first asset based on one or more asset tasks associated with the asset category for the second asset. In one or more embodiments, the one or more asset tasks are associated with a physical activity to be performed on the particular type of physical asset associated with the digital asset template. For example, digital asset template 602 can be associated with asset tasks 608 and 610, where the asset tasks 608 and 610 are data objects associated with a physical activity to be performed on, or by, the particular type of physical asset associated with the digital asset template 602.

In one or more embodiments, one or more asset tasks (e.g., such as asset tasks 608 and 610) can be automatically performed by the particular type of physical asset with which the digital asset template 602 is associated. In one or more embodiments, the parameter values captured by one or more asset tasks (e.g., such as asset tasks 608 and 610) can be automatically stored in a database (e.g., asset entity database 304) and/or a server system related to a particular industrial environment. Additionally or alternatively, one or more asset tasks (e.g., such as asset tasks 608 and 610) can be manually performed by a human operator on a particular physical asset associated with a digital asset instance (e.g., digital asset instance 612) in the industrial environment and any parameter value captured during execution of the asset task can be manually stored in the asset entity database 304 via the user computing device system 303.

In response to the request, the method 1200 also includes a block 1210 that causes a rendering (e.g., by the electronic interface component 508) of visualization data associated with the digital asset template (e.g., visualization data associated with digital asset template data 308) to be presented via an electronic interface of a user computing device. The causing the rendering of visualization data provides one or more technical improvements such as, but not limited to, extended functionality for a user computing device and/or improving accuracy of interactive user interface.

In one or more embodiments, the method 1200 can additionally or alternatively include configuring one or more industrial processes related to the first asset based at least in part on the digital asset template. For example, one or more parameters for the one or more industrial processes can be configured based on the digital asset template and/or data obtained via the rendering of the visualization data associated with the digital asset template.

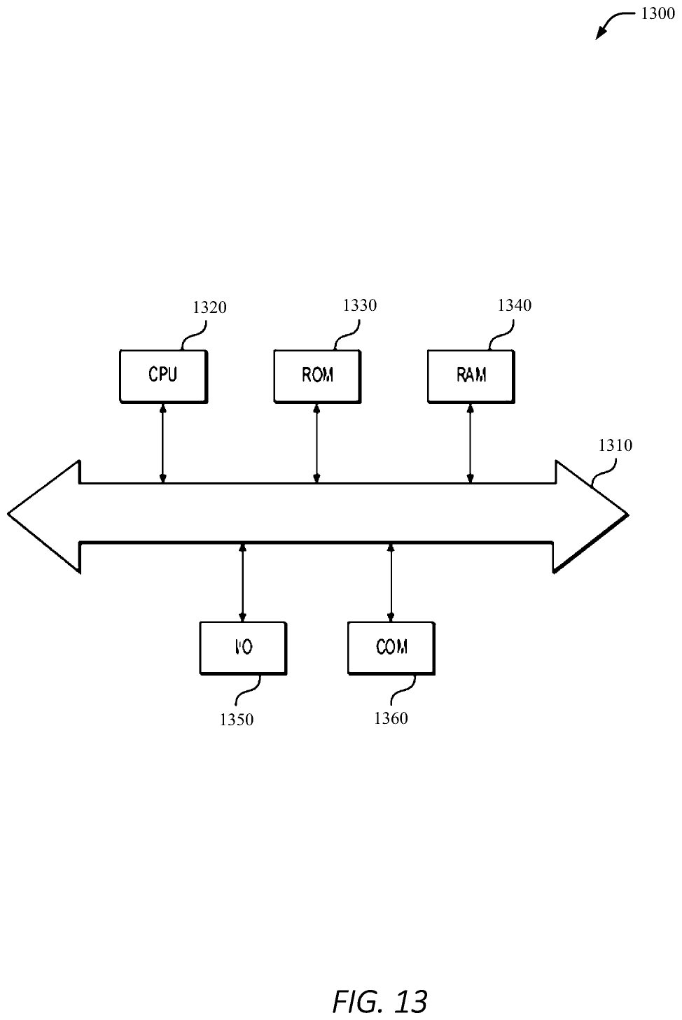

FIG. 13 depicts an example system 1300 that may execute techniques presented herein. FIG. 13 is a simplified functional block diagram of a computer that may be configured to execute techniques described herein, according to exemplary embodiments of the present disclosure. Specifically, the computer (or “platform” as it may not be a single physical computer infrastructure) may include a data communication interface 1360 for packet data communication. The platform also may include a central processing unit (“CPU”) 1320, in the form of one or more processors, for executing program instructions. The platform may include an internal communication bus 1310, and the platform also may include a program storage and/or a data storage for various data files to be processed and/or communicated by the platform such as ROM 1330 and RAM 1340, although the system 1300 may receive programming and data via network communications. The system 1300 also may include input and output ports 1350 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

In some example embodiments, certain ones of the operations herein can be modified or further amplified as described below. Moreover, in some embodiments additional optional operations can also be included. It should be appreciated that each of the modifications, optional additions or amplifications described herein can be included with the operations herein either alone or in combination with any others among the features described herein.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™ or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A system, comprising:
one or more processors;
a memory; and
one or more programs stored in the memory, the one or more programs comprising instructions configured to:
receive a request to generate a digital asset template for a first asset within an industrial environment, wherein the request comprises an asset inheritance identifier related to a second asset within the industrial environment;
in response to the request:
determine an asset category for the second asset based on the asset inheritance identifier;
configure the digital asset template for the first asset based on one or more asset tasks associated with the asset category for the second asset; and
cause a rendering of visualization data associated with the digital asset template to be presented via an electronic interface of a user computing device; and
configure one or more industrial processes related to the first asset based at least in part on the digital asset template.

2. The system of claim 1, the one or more programs further comprising instructions configured to:
determine a change to an asset task for the second asset;
update the one or more asset tasks associated with the asset category to generate one or more updated asset tasks; and
reconfigure the digital asset template for the first asset based on the one or more updated tasks.

3. The system of claim 1, the one or more programs further comprising instructions configured to:
determine one or more measurement points for the one or more asset tasks associated with the first asset based on the asset category; and
cause rendering of data associated with the one or more measurement points via the electronic interface.

4. The system of claim 3, the one or more programs further comprising instructions configured to:
apply a respective operational limit to the one or more measurement points associated with the first asset based on the asset category.

5. The system of claim 3, the one or more programs further comprising instructions configured to:
apply a respective operational limit to the one or more measurement points associated with the first asset based on the asset inheritance identifier.

6. The system of claim 1, the one or more programs further comprising instructions configured to:
determine a new asset task for the second asset;
update the one or more asset tasks associated with the asset category to generate one or more updated asset tasks; and
reconfigure the digital asset template for the first asset based on the one or more updated tasks.

7. The system of claim 1, the one or more programs further comprising instructions configured to:
configure the electronic interface to render an inspection round checklist related to the first asset based on the digital asset template, wherein the inspection round checklist comprises the one or more asset tasks.

8. The system of claim 1, the one or more programs further comprising instructions configured to:
configure, based on the digital asset template, the electronic interface to capture a parameter value associated with an asset task from the one or more assets tasks for the first asset.

9. The system of claim 8, the one or more programs further comprising instructions configured to:
determine an operational limit for the asset task based on the digital asset template;
compare the captured parameter value to the operational limit for the asset task;
determine, based on the comparison of the captured parameter value and the operational limit, whether the captured parameter value exceeds the operational limit; and
trigger one or more actions associated with an industrial process related to the first asset upon a determination that the operational limit is exceeded.

10. A computer-implemented method, the method comprising:
receiving a request to generate a digital asset template for a first asset within an industrial environment, wherein the request comprises an asset inheritance identifier related to a second asset within the industrial environment;
in response to the request:
determining an asset category for the second asset based on the asset inheritance identifier;
configuring the digital asset template for the first asset based on one or more asset tasks associated with the asset category for the second asset; and
causing a rendering of visualization data associated with the digital asset template to be presented via an electronic interface of a user computing device; and
configuring one or more industrial processes related to the first asset based at least in part on the digital asset template.

11. The computer-implemented method of claim 10, the method further comprising:
determining a change to an asset task for the second asset;
updating the one or more asset tasks associated with the asset category to generate one or more updated asset tasks; and
reconfiguring the digital asset template for the first asset based on the one or more updated tasks.

12. The computer-implemented method of claim 10, the method further comprising:
determining one or more measurement points for the one or more asset tasks associated with the first asset based on the asset category; and
causing rendering of data associated with the one or more measurement points via the electronic interface.

13. The computer-implemented method of claim 12, the method further comprising:
applying a respective operational limit to the one or more measurement points associated with the first asset based on the asset category.

14. The computer-implemented method of claim 12, the method further comprising:
applying a respective operational limit to the one or more measurement points associated with the first asset based on the asset inheritance identifier.

15. The computer-implemented method of claim 10, the method further comprising:
determining a new asset task for the second asset;
updating the one or more asset tasks associated with the asset category to generate one or more updated asset tasks; and
reconfiguring the digital asset template for the first asset based on the one or more updated tasks.

16. The computer-implemented method of claim 10, the method further comprising:
configuring the electronic interface to render an inspection round checklist related to the first asset based on the digital asset template, wherein the inspection round checklist comprises the one or more asset tasks.

17. The computer-implemented method of claim 10, the method further comprising:
configuring, based on the digital asset template, the electronic interface to capture a parameter value associated with an asset task from the one or more assets tasks for the first asset.

18. The computer-implemented method of claim 10, the method further comprising:
determining an operational limit for the asset task based on the digital asset template;
comparing the captured parameter value to the operational limit for the asset task;
determining, based on the comparison of the captured parameter value and the operational limit, whether the captured parameter value exceeds the operational limit; and
triggering one or more actions associated with an industrial process related to the first asset upon a determination that the operational limit is exceeded.

19. A computer program product comprising at least one computer-readable storage medium having program instructions embodied thereon, the program instructions executable by a processor to cause the processor to:
receive a request to generate a digital asset template for a first asset within an industrial environment, wherein the request comprises an asset inheritance identifier related to a second asset within the industrial environment;
in response to the request:
determine an asset category for the second asset based on the asset inheritance identifier;
configure the digital asset template for the first asset based on one or more asset tasks associated with the asset category for the second asset; and
cause a rendering of visualization data associated with the digital asset template to be presented via an electronic interface of a user computing device; and
configure one or more industrial processes related to the first asset based at least in part on the digital asset template.

20. The computer program product of claim 19, wherein the program instructions further cause the processor to:
determine a change to an asset task for the second asset;
update the one or more asset tasks associated with the asset category to generate one or more updated asset tasks; and
reconfigure the digital asset template for the first asset based on the one or more updated tasks.
